(19) United States
(12) Patent Application Publication
(10) Pub. No.: US 2019/0139163 A1
(43) Pub. Date: May 9, 2019

(54) METHOD FOR FORECASTING ENERGY DEMANDS THAT INCORPORATES URBAN HEAT ISLAND

(71) Applicant: Research Foundation of the City University of New York, New York, NY (US)

(72) Inventors: Jorge E. Gonzalez-Cruz, Baldwin, NY (US); Mark Arend, Little Silver, NJ (US); Thomas Legbandt, New York, NY (US); Estatio Gutierrez, New York, NY (US); Fred Moshary, New York, NY (US); Luis Ortiz, New york, NY (US)

(21) Appl. No.: 16/189,624

(22) Filed: Nov. 13, 2018

Related U.S. Application Data
(63) Continuation-in-part of application No. 14/530,099, filed on Oct. 31, 2014.
(60) Provisional application No. 62/584,294, filed on Nov. 10, 2017.

(51) Int. Cl. G06Q 50/06; G06N 5/04

(52) U.S. Cl. CPC G06Q 50/06; G06Q 10/04; G06N 5/04

(57) ABSTRACT

A method for forecasting energy demand for a single building, a neighborhood or a city in an urban environment is disclosed. The method balances energy production between (1) a renewable energy source and (2) an energy grid source based in predicted demand and predicted supply. The method treats urban heat island (UHI) calculations as being dynamically impacted by predicted weather conditions to calculate a weather-adjusted UHI. Predicted energy consumption rates for weather conditions use the weather-adjusted UHI to increase accuracy of the prediction.

### CROSS-REFERENCE TO RELATED APPLICATIONS

This application claims priority to and is a non-provisional of U.S. Patent Application 62/584,294 (filed Nov. 10, 2017), the entirety of which is incorporated herein by reference. This application also claims priority to and is a continuation-in-part of U.S. patent application Ser. No. 14/530,099 (filed Oct. 31, 2014), the entirety of which is incorporated herein by reference.

### STATEMENT OF FEDERALLY SPONSORED RESEARCH OR DEVELOPMENT

This invention was made with Government support under Contract Number NA060AR4810162 awarded by the National Oceanic and Atmospheric Agency and Contract Numbers 0933414 and 1439606 awarded by the National Science Foundation.

### BACKGROUND OF THE INVENTION

The subject matter disclosed herein relates to methods of forecasting energy consumption of building(s) in an urban environment. The forecasting of energy demands for buildings is currently based on historical records of energy demands for given locations. These locations may include electrical sub-stations, single buildings, or blocks of buildings. A variety of utility companies use this approach to prepare a power grid and the corresponding energy production, particularly in peak demand conditions. This approach has not proven entirely satisfactory as actual demand often does not correspond with the predicted demand. The gap is particular pronounced during extreme weather (e.g. heat waves) in urban centers with a dense population. An improved method of forecasting energy demands is therefore desired.

The discussion above is merely provided for general background information and is not intended to be used as an aid in determining the scope of the claimed subject matter.

### BRIEF DESCRIPTION OF THE INVENTION

A method for forecasting energy consumption for a single building, a neighborhood or a city in an urban environment is disclosed. The method treats urban heat island (UHI) calculations as being dynamically impacted by predicted weather conditions to calculate a weather-adjusted UHI. Predicted energy consumption rates for weather conditions use the weather-adjusted UHI to increase accuracy of the prediction. An advantage that may be realized in the practice of some disclosed embodiments of the method is that more accurate forecasts of energy consumption can be made for urban environments.

In a first embodiment, a method for forecasting energy demand for a building in an urban environment is provided. The method comprising steps of: determining a predicted weather condition of an urban environment at a predetermined time using a weather forecasting model; finding, using a building energy model, an impact of the predicted weather condition on an urban heat island (UHI) of the urban environment, the step of finding producing a weather-adjusted UHI condition; quantifying a predicted energy consumption rate for a building in the urban environment at the predetermined time based on the weather-adjusted UHI condition that incorporates the impact of the predicted weather condition on the urban heat island (UHI), wherein the building energy model segments the urban environment into uniform grids with a grid size, the grid size selected to group buildings with a uniform horizontal distribution together; forecasting renewable energy power production for the building in the urban environment, wherein the renewable energy power production is produced by a renewable energy source; estimating an energy deficit from the renewable energy source by finding a difference between the predicted energy consumption rate and the renewable energy power production; balancing energy production between (1) the renewable energy source and (2) energy from an energy grid source, the balancing being based on the energy deficit.

In a second embodiment, a method for forecasting energy demand for a building in an urban environment is provided. The method comprising steps of: determining a predicted weather condition of an urban environment at a predetermined time using a weather forecasting model; finding, using a building energy model, an impact of the predicted weather condition on an urban heat island (UHI) of the urban environment, the step of finding producing a weather-adjusted UHI condition; quantifying a predicted energy consumption rate for a building in the urban environment at the predetermined time based on the weather-adjusted UHI condition that incorporates the impact of the predicted weather condition on the urban heat island (UHI), wherein the building energy model segments the urban environment into uniform grids with a grid size, the grid size selected to group buildings with a uniform mean building height together; forecasting renewable energy power production for the building in the urban environment, wherein the renewable energy power production is produced by a renewable energy source; estimating an energy deficit from the renewable energy source by finding a difference between the predicted energy consumption rate and the renewable energy power production; balancing energy production between (1) the renewable energy source and (2) energy from an energy grid source, the balancing being based on the energy deficit.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is an exemplary output from one disclosed method wherein power consumption rate of air conditioners (AC) is shown for New York City (NYC);

FIG. 2 is a schematic depiction of Building Energy Parameterization (BEP) and a Building Energy Model (BEM) for an exemplary urban area;

FIG. 3 depicts surface temperatures from NYCMetNet observations on Jul. 6, 2010 at 1400 ET;

FIG. 4 depicts surface temperature from NYCMetNet observations as a function of time from Jul. 5, 2010 to Jul. 7, 2010;

FIG. 5 shows building height in meters while FIG. 6 shows change in building height in meters;

FIG. 7 shows national data land cover dataset while FIG. 8 shows corrected data land cover dataset;

FIG. 9 shows surface temperature simulations using an urban morphological approach while FIG. 10 shows surface temperature simulations using a grid approach;

FIG. 11 shows root mean square error (RMSE) using an urban morphological approach while FIG. 12 shows RMSE using a grid approach;

FIG. 13 shows surface temperature simulations on Jul. 6, 2010 at 15:00 ET for buildings with dark roofs while FIG. 14 shows surface temperature simulations for the same time for white roofs;

FIG. 15 shows dark roof and white roof hourly surface temperature simulations on Jul. 6, 2010 for a location in Midtown Manhattan;

FIG. 16 shows dark roof and white roof hourly power consumption for ACs on Jul. 6, 2010 for the location in Midtown Manhattan;

FIG. 17 shows dark roof hourly power consumption for ACs on Jul. 6, 2010 for an urban area;

FIG. 18 shows white roof hourly power consumption for the urban area;

FIG. 19 depicts a graph of baseline city-wide load derived from the NYISO load data;

FIG. 20 depicts a map showing nested domains used by an urbanized model;

FIG. 21A shows a map of three weather station locations; FIG. 21B shows a time series of temperature changes over time for the three weather station locations; FIG. 21C shows box plots corresponding to FIG. 21B;

FIG. 22 is a graph showing Root Mean Square Error (RMSE) and mean absolute error (MAE) for the three weather stations;

FIG. 23 shows average peak distribution of air conditioning load taking into account both the weather effects and the parameterized urban morphology;

FIG. 24 is a graph showing distribution of forecast and NYISO loads;

FIG. 25 is a graph representing global horizontal irradiance (GHI) at Brookhaven, N.Y. as a function of time; and

FIG. 26 is a graph of the components of incoming solar resources.

### DETAILED DESCRIPTION OF THE INVENTION

The disclosed method forecasts energy demands for buildings within a domain (block, city, region), under a predicted weather event; past, present or future. The disclosed method uses existing high resolution weather prediction models coupled to building energy models to forecast energy demands of buildings within cities and for the entire city. The disclosed approach accommodates for weather fluctuations that deviate from long-term norms, and/or spatial characteristics of the neighborhood and or city by considering real time temporal fluctuations of local weather and specific characteristics of buildings, neighborhoods, and cities, including; building heights, materials, optical properties, HVAC and energy generation systems used, and usage by occupants. The forecasting of energy demands for neighborhoods and cities has a wide range of potential applications for; a) utility companies to anticipate demands on their electrical and gas grids, b) for building managers to anticipate operation of energy production and heating, ventilating, and air conditioning (HVAC) equipment, c) for data centers to optimize their operation, d) for carbon market businesses to anticipate stocks, e) for renewable energy technologies to anticipate production, and f) for urban/building planners, among many other potential users.

The method uses an existing weather forecasting model, such as the Weather Research and Forecasting (WRF) mesoscale model, that is coupled to a building energy model. The building energy model considers thermal and mechanical effects of an urban environment including a building scale energy model to account for anthropogenic heat contributions due to indoor-outdoor temperature differences. Building electrical consumption from commercial and residential buildings during the summer is mostly associated with the use of air conditioning to maintain indoor human comfort conditions. The building energy model uses three-dimensional (3D) building characteristics, geo-spatially organized into uniform grids representing a neighborhood or a city that is initialized by traditional weather forecasting data such as North American Mesoscale (NAM) output or equivalent.

The method is particularly useful in urban environments where urban heat islands are particularly pronounced. In one embodiment, the urban environment is segments into grids wherein at least one grid has at least 20% of the buildings with a height of at least ten meters. In another embodiment, at least one grid in the urban environment has at least 40% of the buildings with a height of at least ten meters.

In one embodiment, an energy forecasting tool is provided that comprises a software application tangibly embodied in a non-transient computer-readable storage medium. The energy forecasting tool comprises a) a weather forecasting modeling coupled to a building energy model, b) a building data set for a specific location for use by the building energy model, c) four-dimensional (4D) initial and boundary conditions, and d) an efficient computing hardware system to execute forecasting. Typical computer resources with 2014 technology use more than 100 processors operating in parallel and several terabytes (TB) of storage.

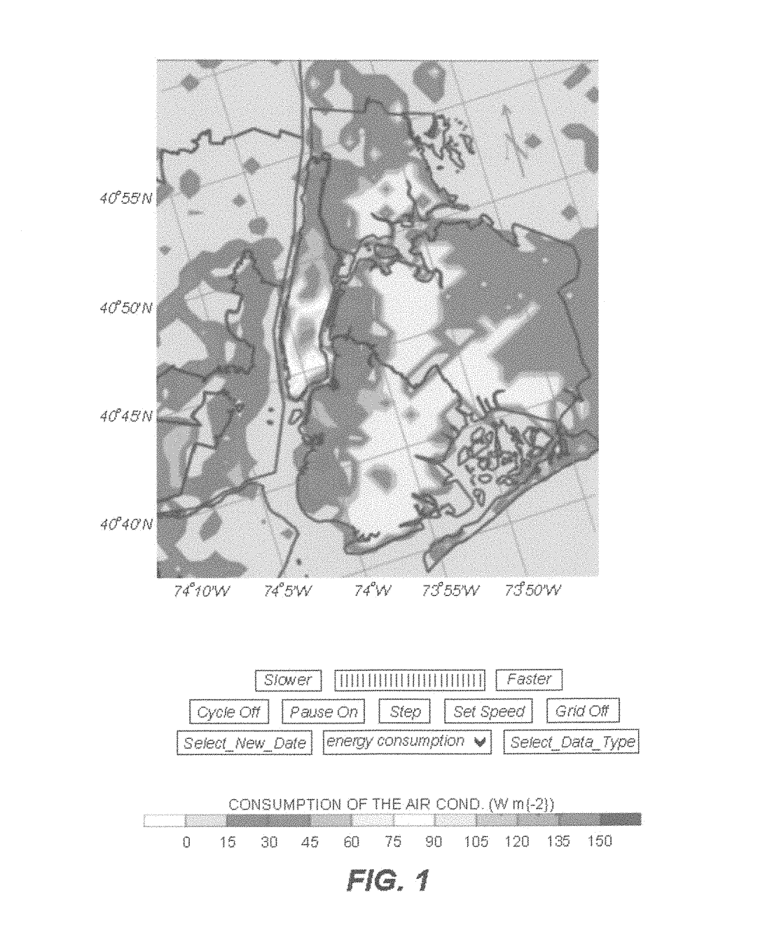

The output of the disclosed method includes; typical weather data (wind, temperature, humidity, etc.) and energy demands for each building grid (in W/m² or kWh) or for an entire neighborhood or city, as a function of weather conditions and usage of the building. The information is provided at temporal resolutions that can vary from minutes to days, and spatial resolutions can vary from a few meters to a few kilometers, in two-dimensions (2D) or three-dimensions (3D). An example of the output is shown in FIG. 1, where energy is being forecasted for Aug. 21, 2013 for the entire New York City.

In an exemplary embodiment, the disclosed method is used to evaluate a resulting urban heat island (UHI) formation associated to a multi-day (e.g. three-day) heat wave in a metropolitan area (e.g. New York City (NYC)) over a predetermined time period (e.g. during the summer of 2010).

As a comparative example, a series of simulations were conducted with both a single building energy model (SBEM), such as the U.S. Department of energy EQUEST™ and ENERGYPLUS™ and an urbanized weather forecasting model (uWRF). ENERGYPLUS™ is a tool developed by the US Department of Energy for analyzing energy dynamics of single buildings and is useful for designing and sizing HVAC equipment. Such SBEM systems account for direct, diffuse and reflected solar radiation, longwave thermal radiation from the environment, convective exchange with air, conductive heat flux into walls, radiation from internal sources (e.g. computers, lights, office equipment, etc.) and radiation from other zones. Some SBEM tools also incorporate the effects of shadows created by surfaces of the building due to the changing position of the sun. Building energy consumption due to air conditioner use was modeled at an Uptown location (coordinates 40.822631, −73.951367) and a Midtown location (coordinates 40.759302, −73.969148) in Manhattan which represented a low density and a high density building area. The modeling was conducted using SBEM driven by Typical Meteorlogical Year (TMY) weather file. The SBEM model showed the uptown location consumed 137% more energy during a Jul. 4-8, 2010 heat wave while the Midtown location consumed 125% more energy compared to a typically July three-day period. The urban heat island (UHI) during this period was recorded at a maximum of 4° C. in the night and at 2° C. during the hottest day. In comparison to energy consumption modeled using the disclosed method, the SBEM model underestimated total energy consumption within a factor of three. Without wishing to be bound to any particular theory, it is believed the SBEM fails to take into account urban heat island (UHI) effects such as anthropogenic sources and waste heat interactions between surrounding buildings. SBEM models are primarily driven by TMY weather files and do not account for UHI.

In this example, a historical time period is selected for demonstration purposes but the method is equally applicable to future time periods. High-resolution (250 m) urban canopy parameters (UCPs) from the National Urban Database were employed to initialize the multilayer urban parameterization. The precision of the numerical simulations was evaluated using a range of observations. Data from a dense network of surface weather stations, wind profilers, and Lidar measurements are compared to model outputs over Manhattan and its surroundings during the 3-days event. Thermal and drag effects of buildings represented in the multilayer urban canopy model improves simulations over urban regions giving better estimates of the 2 m surface air temperature and 10 m wind speed. An accurate representation of the nocturnal urban heat island registered over NYC in the event was obtained from the improved method. The accuracy of the method was further assessed against more simplified urban parameterizations models with positive results. The method was also used to quantify the energy consumption of the buildings during the heat wave, and to explore alternatives to mitigate the intensity of the UHI during the heat wave.

The UHI has a substantial impact on meteorological conditions of urbanized regions. The main contributing factors to temperature differences between urban and rural environment are changes in physical characteristics of surface such as albedo, thermal capacity and heat conductivity due to the replacement of vegetation by asphalt and concrete; decrease of surface moisture available for evapotranspiration; changes in radiative fluxes and in the near-surface flow due to the complicated geometry of streets and tall buildings, and anthropogenic heat. The UHI circulation associated with an urban area can significantly alter lower tropospheric winds and low-level pollutant dispersion. UHI formation occurs when urban structures store solar energy during the daytime. This energy is released as sensible heat at nighttime while the heat flux to the ground in rural areas produce a decrease on the surface temperatures in urban surroundings. The UHI increases during the afternoon to reach a maximum during the night and decreasing after dawn. UHI could has significant impacts on air quality and energy demands. Reports for the city of Los Angeles show an energy demand impact of 500 MW per ° C. of UHI increase. These estimates are based on historical records of UHI trends and energy.

UHI magnitude depends on local conditions like wind speed and cloud cover. High wind speeds reduce the UHI through the ventilation of the urban area while clouds diminish the negative heat flux over rural regions. Urban-rural temperature difference is greatest on clear nights with low humidity through-out the troposphere and gentle northwest winds. The urban-rural temperature difference is strongly reduced by sea breezes and backdoor cold fronts during spring and summer. In the NYC area, wind speed has strongly declined over the century due to the increase of building heights intensifying the UHI. The UHI spatial extent also depends on many spatial variables, such as surface moisture and vegetation cover, in addition to those listed above. Without out wishing to be bound to any particular theory, this is believed to be an indication that the UHI should be viewed as a dynamic meteorological phenomenon and not as a constant, uniform feature.

Urban effects in mesoscale models have been represented using different techniques and parameterizations. The disclosed method takes into account the impact of a city on the momentum, turbulence, and the heat exchanges. The first approach to modify the dynamics in the models was increasing roughness over urban areas assuming that turbulent fluxes were constant with height. Most of the mesoscale models use this method to represent flow dynamics over cities. The urban surface exchange parameterization incorporated into the latest version of WRF employs a very high vertical resolution with several layers within the urban canopy where a sink term is introduced in the momentum equation to represent the drag induced by the buildings.

The reduction of the total albedo and the nocturnal radiation loss caused by the buildings is parameterized through the calculation of the energy budget for walls and streets where the street directions and wind speed in the canopy are important factors. The shadowing and radiation trapping effects constitute important components of the surface energy balance. In this example, the WRF model is coupled with a multilayer urban layer urban parameterization to simulate the evolution of the surface temperature during a heat wave over New York City and the energy consumption associated to this heat wave by the city. The energy consumption and heat release response during an extreme heat event and possible mitigation alternatives were also determined.

### Model Configuration

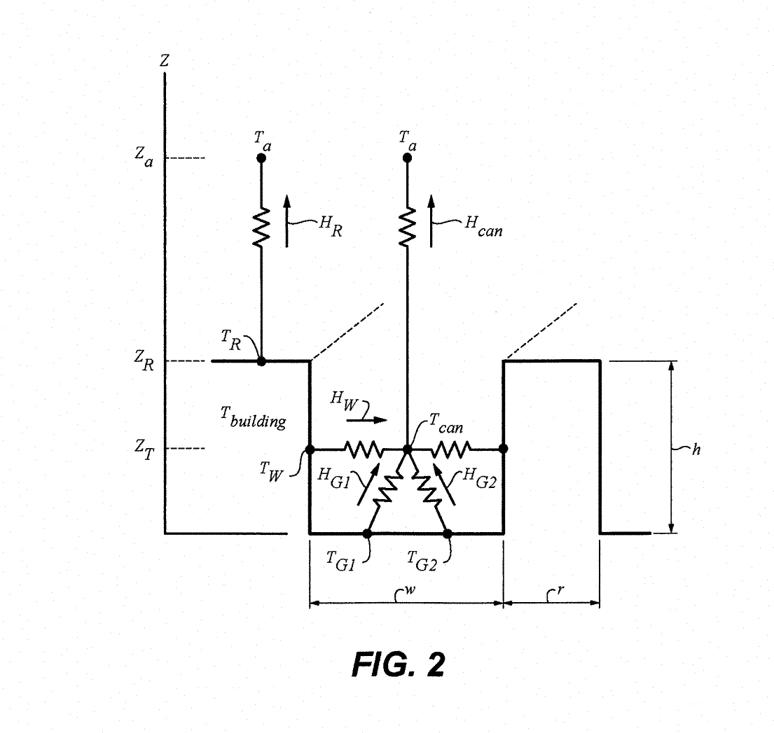

The mesoscale WRF model, coupled to a multilayer urban parameterization, is used to simulate the evolution of surface temperature and energy consumption and associated heat release to the environment during a heat wave event over New York City from Jul. 4-8, 2010. The new urban model incorporated from WRF version 3.2 comprises a Building Energy Parameterization (BEP) and a Building Energy Model (BEM). BEP accounts for impacts from horizontal and vertical building surfaces in the momentum, heat, and turbulent kinetic energy equations. BEM, for each building floor (FIG. 2), considers the diffusion of heat through walls, roofs and floor; natural ventilation; radiation exchange between indoor surfaces; generations of heat due to occupants and equipments and the consumption due to air conditioning (AC) systems. Both BEP and BEM work together to predict urban weather and energy consumption. The buildings in the exemplary model were assigned a square shape, an area of 625 square meters, three floors, a street width of 25 meters, a building width of 20 meters, an urban fraction of 1, a DX cooling coil as a cooling system, a heat capacity of 1.32 MJ 111⁻³ K⁻¹ (e.g. concrete) and thermal conductivity equal to 0.6 J s⁻¹ K⁻¹. Windows have a coverage fraction of 0.2, an isolation transmittance of 0.3 and a surface window coefficient of 2.8 W K⁻¹ m⁻². The coefficient of performance of the AC system was set to 2.8 with a heat exchanger thermal efficiency of 0.75. An equipment gain of 36 w per square meter was set. Additional energy parameters are available from local building codes. These building parameters can be adjusted to better represent individual buildings within the grid or for entire cities.

Four two-way nested domains were constructed with spatial grid resolution of 9, 3, 1, and 0.333 km which contained 70×70, 61×61, 61×61, and 100×100 grid boxes, respectively, from west to east and north to south. Fifty one terrain following sigma levels were defined with twenty levels in the first kilometer. The Bougeault-Lacarrere (BouLac) planetary boundary layer scheme was adopted. This turbulent kinetic energy prediction option was designed for use with BEP/BEM urban models. The Single Moment 3-class and Kain-Fritsch scheme were the microphysics and cumulus options selected. The cumulus parameterization was only applied to the course domain and the first nest. The initial and boundary conditions for WRF were obtained from the North American Mesoscale (NAM) data sets with 12 km resolution at 3h intervals. NCEP/MMAB data at 0.5 deg were employed to update the sea surface temperature every 24 h.

### Data Sources

In addition to surface and meteorological initial and boundary conditions, the urbanized mesoscale model uses an extra set of specific input parameters that describe the complex arrangement of buildings and streets on an urban environment. The general approach is to represent the city in a simpler way where all the buildings within the grid cell have the same horizontal distribution and are located at the same distance from each other. The WRF model uses data from the National Building Statistics Database (NBSD2), developed at Los Alamos National Laboratory, that has a set of thirteen building statistics computed at 250 m spatial resolution from three-dimensional digital building data for several metropolitan areas in the USA. The buildings statistics included in NBSD2 are mean building height, height histograms, plan area fraction, height to width ratio, sky factor among others. For New York, NBSD2 data are available for Manhattan, part of the boroughs and New Jersey next to the East and Hudson rivers, respectively. The grid size may be selected to group buildings with one or more uniform building statistics together. As used in this specification, the term uniform generally refers to a grid wherein at least 40% of the buildings are within 10% for the measured parameter. For example, a grid with uniform height has at least 40% of the buildings within 10% of the average height of the buildings within the grid. The current version of the model uses New York City Building Tax Lot Data which reduced uncertainties for the building distribution across the City. Similar approaches to represent the buildings can be used for other cities worldwide.

The NYCMetNet is a permanent meteorological observing network for the greater NYC metro area that brings together a number of regional observing networks. In this example, thirty-six surface stations from the Citizen Weather Observer Program, Earth Networks, Inc., Weatherflow, Inc., Automated Surface Observing Systems and the Remote Automated Weather Stations were used to validate the model simulations with the urban parameterization.

### Heat Wave Synoptic Pattern

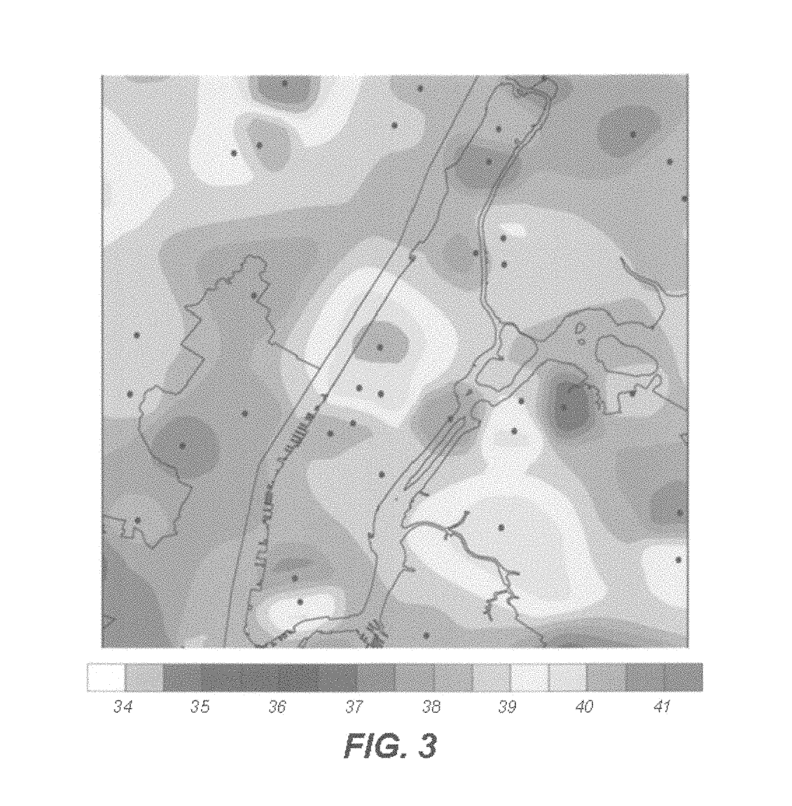

A heat wave affected the east coast from Jul. 4-8, 2010 with maximum surface temperatures that exceeded 32° C. (90° F.). The large scale conditions associated with the heat wave included a strong subtropical ridge at 500 hPa, an intense surface high, weak west-northwesterly flow, and deep warm air from the surface to 700 hPa. Warm air from the plains was moved eastward by the subtropical ridge bringing high temperatures to the east coast. NYCMetNet data show temperatures on July 6 at 1500 ET reaching values around 38° C. (100° F.) all over New York City and 40° C. (104° F.) in some parts of Manhattan. See FIG. 3.

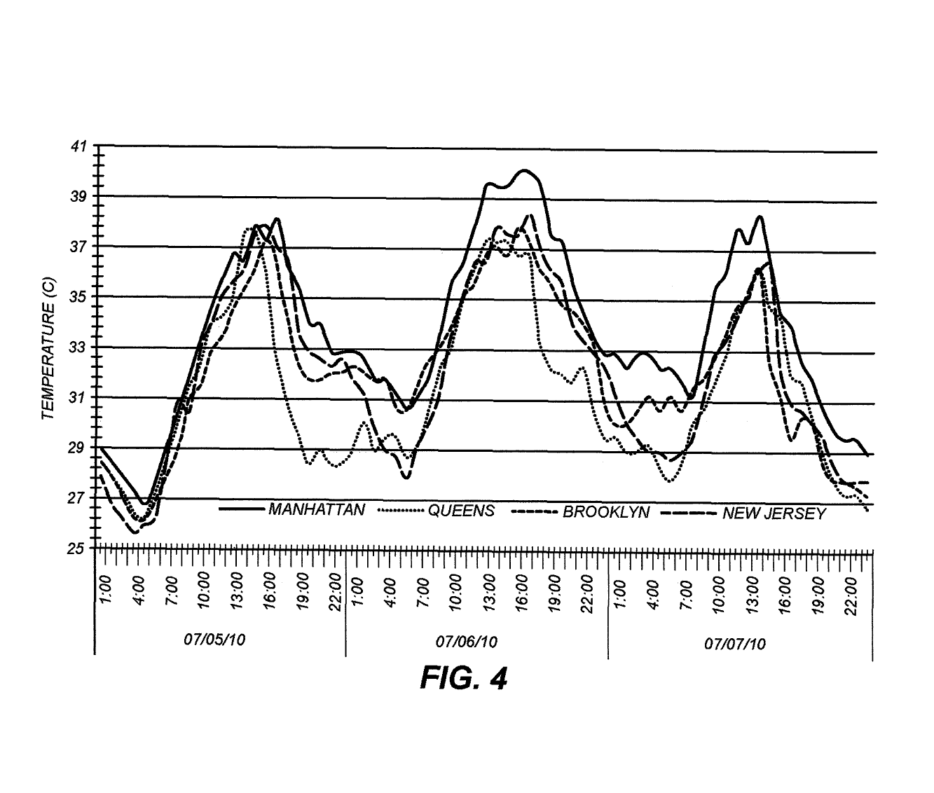

The ridge weakened and shifted westward after three days. The urban heat island produced by the highly developed urban environment over Manhattan is maintained throughout the heat wave. See FIG. 4. Despite of the evident nocturnal nature of the UHI with temperature differences of 4° C., a strong signal was registered also during the day with an UHI magnitude of 2° C. at the time when the surface temperature reached its maximum values.

### NBSD2 Assimilation Comparison

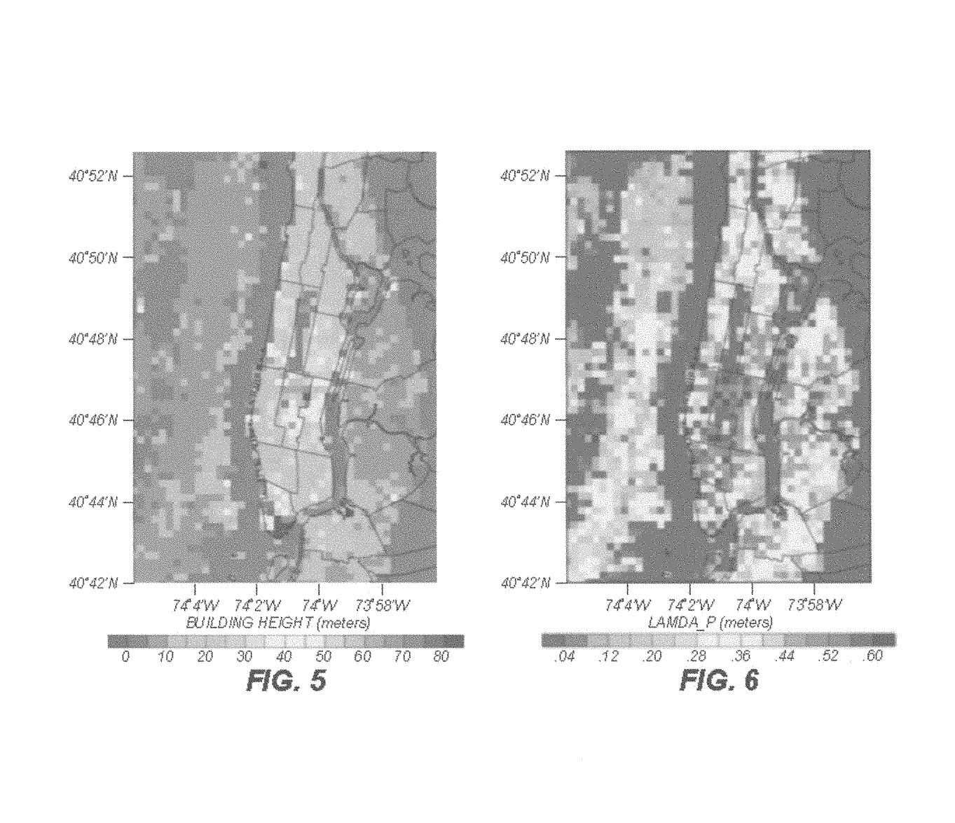

In the actual configuration of WRF, three urban classes are defined: low residential, high residential and industrial (a morphological approach). For each class, average values for the UCPs are ingested on the urban parameterization using a table. Instead of calculating the UCPs mean values corresponding to the urban classes, another approach assimilates the NBSD2 data as a grid. This technique allows a better representation of the buildings' spatial distribution with taller buildings located in Downtown and Midtown Manhattan. See FIG. 5 and FIG. 6. The morphological approach tends to overestimate UCPs values in areas like Uptown and New Jersey.

The land cover/land use classification (LCLU) is an important component to accurately represent the meteorological conditions in an urban environment. The LCLU classification available that includes the three urban classes was obtained from USGS National Land Cover Dataset (NLCD) from 2001. The criteria to categorize a region in one of the urban classes are the same for the whole country. These criteria underestimate the spatial variations in highly heterogeneous cities like New York. A new land cover/land use classification was adopted based on the distribution of the Building Plan Area Fraction. Additionally, a correction for Central Park was implemented to substitute grid points that were erroneously classified in the original classification as urban inside the park.

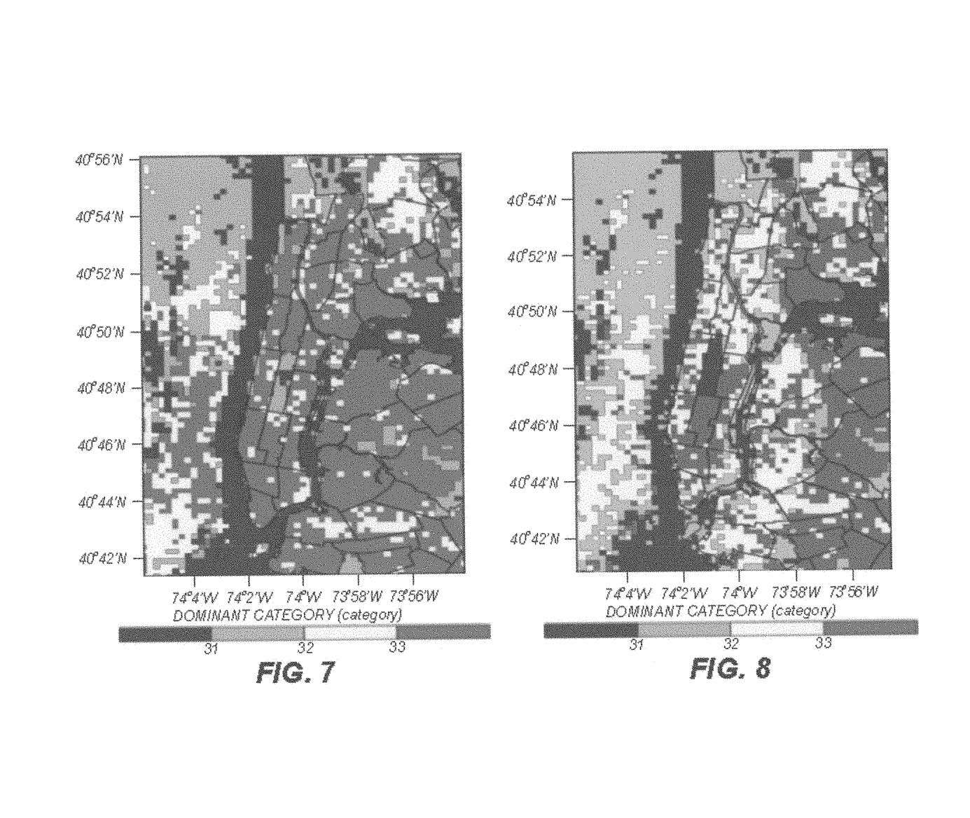

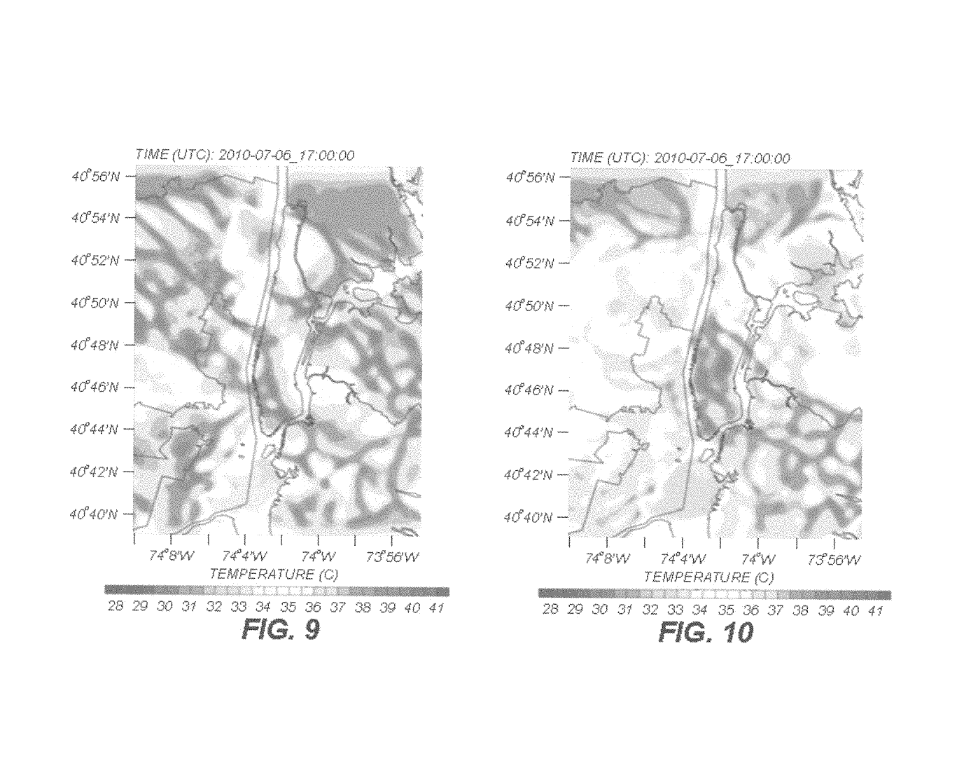

FIG. 7 and FIG. 9 shows the urban land cover distribution of the original NLCD map and the corrected one. In the corrected classification, highly dense urban areas inside Manhattan such as Midtown and Downtown are classified properly as high residential while Uptown, parts of New Jersey, Queens and Brooklyn are categorized as low residential or industrial. The regions outside the NBSD2 coverage maintained their original class which is mainly high residential.

To determine the impact on the surface temperature of the building energy model used, two simulations were performed. In the first simulation (morphological approach), average values were computed for the UCPs for each urban class, whereas in the second approach (grid approach) the urban parameters were assimilated as a grid with a resolution of 333 m. The modified land cover/land use classification was also used in the second case when spatially distributed variables like albedo and heat capacities were not available. In general, the effect of a more detailed representation of the building distribution was an increase of the surface temperature over Midtown and Downtown Manhattan and a decrease in the surrounding boroughs (FIG. 9 and FIG. 10). The table approach clearly overestimates the building characteristics over New Jersey where differences of 3° C. were registered between both simulations.

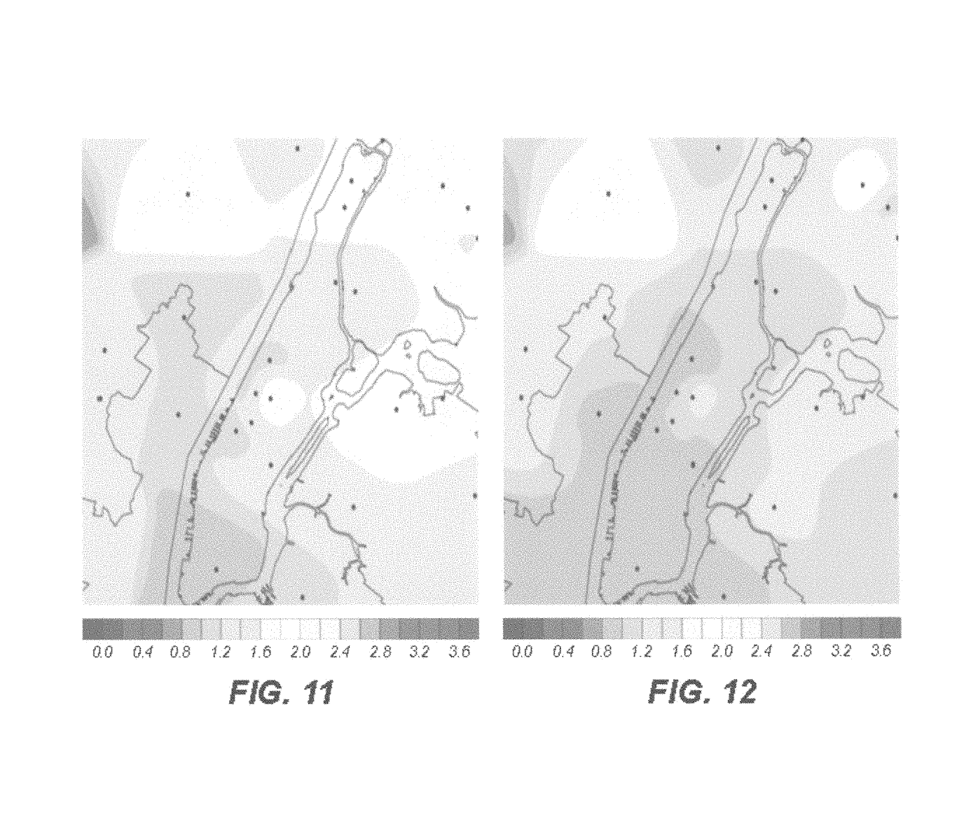

NYCMetNet's surface temperature data for Manhattan and its surroundings were compared to the results of both simulations. The Root Mean Square Error (RMSE) for a 24-h period starting on Jul. 5, 2010 at 8 PM EST was calculated (FIG. 11 and FIG. 12). FIG. 11 shows the RMSE for the urban morphological approach while FIG. 12 shows the RMSE for the grid approach. The grid approach reduces the error around the whole domain with a predominant decrease over Midtown/Downtown Manhattan, Bronx and New Jersey. The cooling effect of Central Park is underestimated in some degree by the model. However Central Park station, from an analysis with sixteen years of data, did not stand out as unusually cool compared to other urban stations around the city. The park's cool island reaches its maximum in summer nights when the neighboring urban streets are significantly warmer than the park itself.

Citywide albedo levels are known to significantly mitigate the urban heat island and reduce the consumption due to cooling. A parametric study was performed using the multilayer urban parameterization to determine the response of the surface temperature and the energy consumption to the change of the roof albedo. Two roof classes were defined. For highly reflective roofs or white roofs an albedo value of 0.8 was assigned. For dark roofs, the albedo used was 0.2.

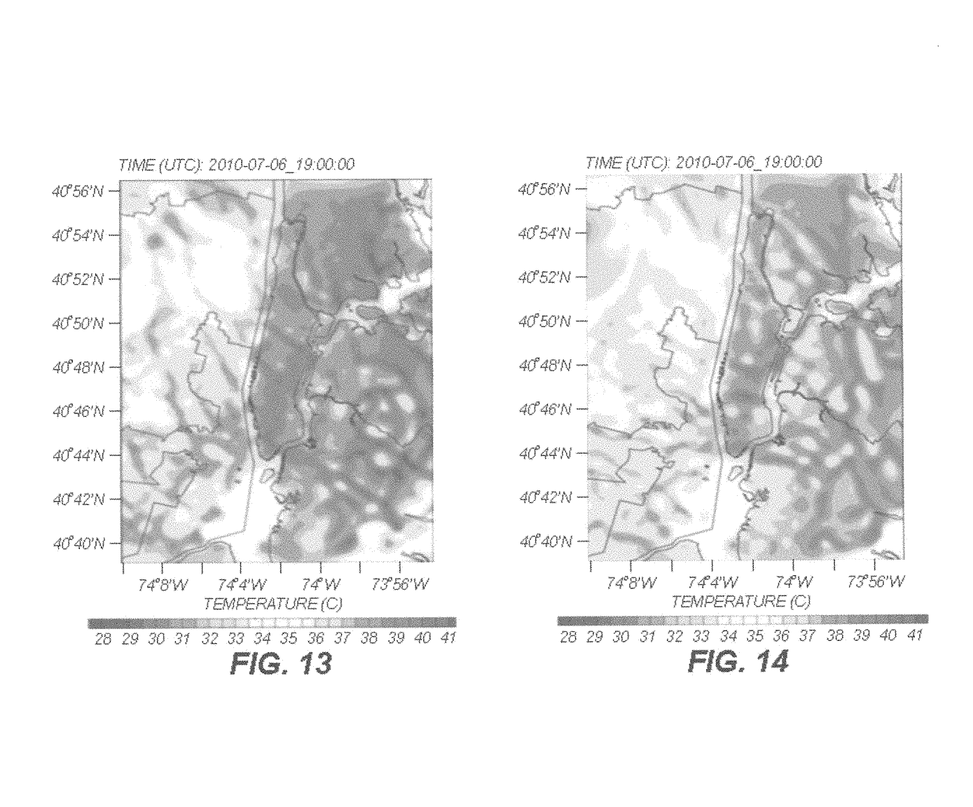

Surface temperature was reduced at least by one degree over Manhattan and its surrounding boroughs due to the increase of the roof albedo (FIG. 13 and FIG. 14).

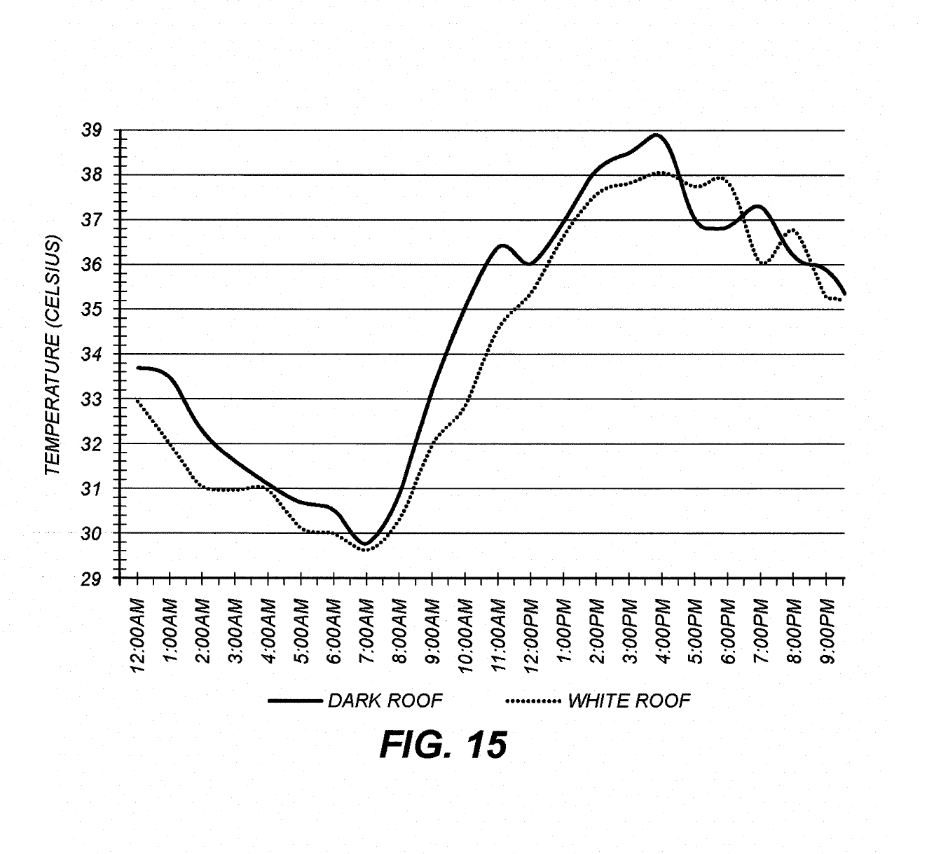

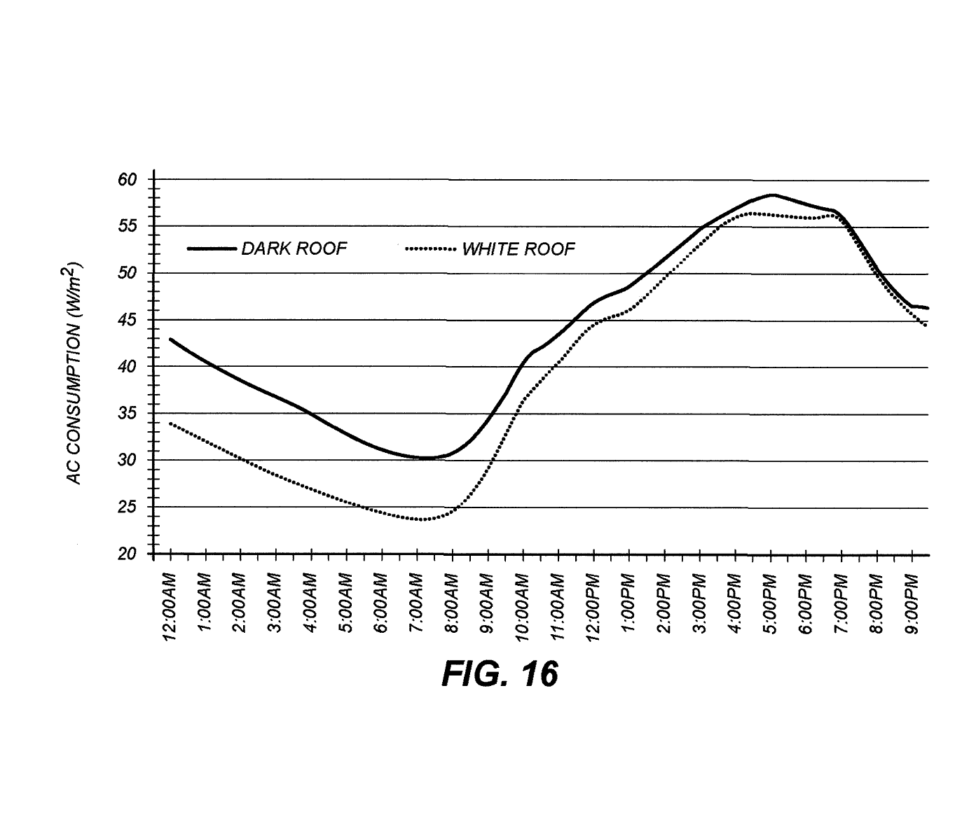

A time series analysis from a model grid cell located at Midtown Manhattan shows that the surface temperature reduction was registered for most of the 24-h period for July 6 (FIG. 15). During the day, the increase in the albedo reduced the temperature and also the amount of energy accumulated by the paved structures. As a result, less sensible heat was released and cooler temperatures were registered during the night compared to the dark roof simulations. The decrease on nighttime surface temperature due to dark and white roof hourly AC energy consumption simulations on Jul. 6, 2010 for a location in Midtown Manhattan white roofs directly affects the development of the urban heat island over NYC. See FIG. 16. On average, UHI increases rapidly in the late afternoon, remains almost constant during the night reaching temperature differences between urban and rural of 4° C. during the summer, and then decreases quickly after dawn.

### Energy Demands During Heat Wave

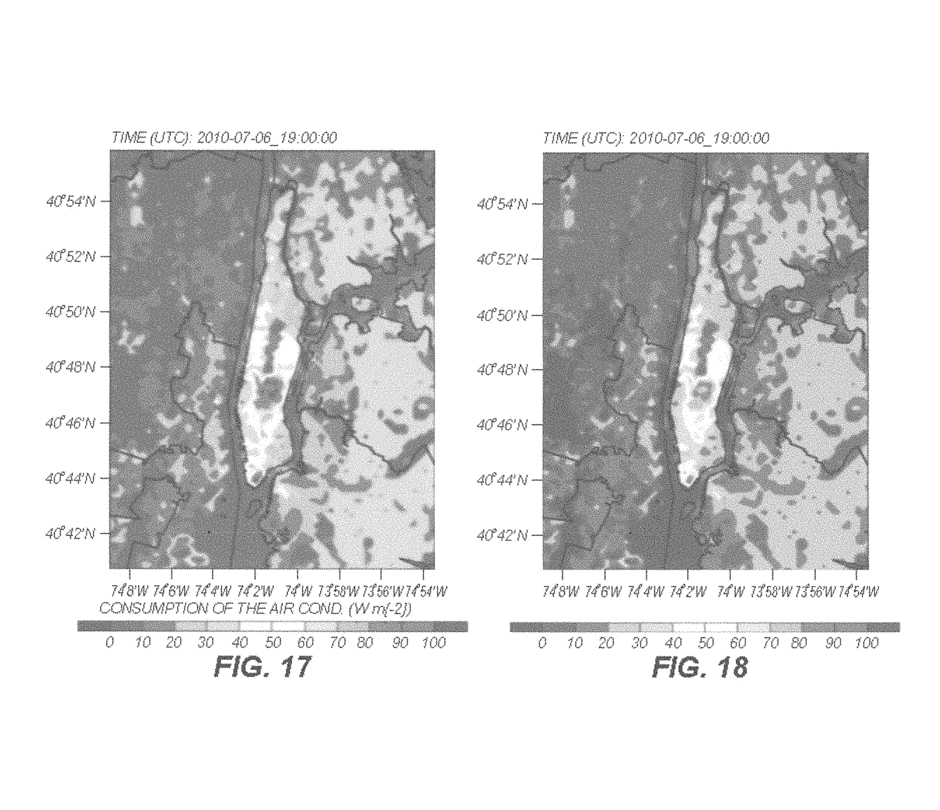

Variations in energy consumption are due to many factors such as ambient weather, building characteristics and occupancy. Occupancy (occupants per floor) and building properties like number of floors and building area are taken into account by the model to determine the energy load associated with AC systems. The target indoor temperature was set to 25° C. with a comfort range of 1° C. The A/C system operates without time restrictions. The system was activated when the outdoor temperature was warmer than indoor temperature regardless of the time of the day. For the specific case of the heat wave, this condition was met for almost the whole simulation period producing significant heat loads during nighttime. AC consumption clearly matches the building height distribution with higher values in Midtown and Downtown Manhattan where the tallest buildings are located that are classified as commercial. See FIG. 17 (dark roof) and FIG. 18 (white roof).

Consumption in the highly dense areas of the city reached about 90 W/m² at the time of the maximum temperature. This value is representative from AC consumption in commercial dwellings and consistent with empirical data for anthropogenic heat from buildings for different cities. They reported that the average hourly anthropogenic heat release for locations close to New York City (Philadelphia was the closes city reported) in the summer varies between 50 and 70 W/m² including electricity, heating fuel, transportation, and metabolism data. We expect higher values during an extreme heat event. For the same Midtown location a time series for July 6 shows the difference in energy consumption caused by the cool roofs (FIG. 16). In both cases, the consumption closely follows the daily temperature trend with maximum values in the afternoon and minimums at the early morning. The albedo has a bigger impact after midnight when the consumption difference between cases reaches about 7 W/m² and remains almost constant until dawn. In peak electricity load hours, reductions are limited to less than 5%. Individual mitigation strategies are known to produce small reductions (<1%) in peak hours and the influence of vegetation on urban climate is more important than the influence of the albedo of built surfaces.

A mesoscale analysis of the surface temperature and energy consumption distribution, associated with a heat wave around New York City was presented using numerical simulations from WRF coupled with a new multilayer urban parameterization. Spatially distributed urban canopy parameters reduce the error in the simulation of the surface temperature in highly heterogeneous cities. However, for areas where these kinds of data are not available, average values still give a reasonable estimation of the city's morphology that allows the use of the multilayer urban parameterization.

Highly reflective roofs tended to decrease the surface temperature over the region which produced a reduction in the energy consumption. The effect of cool roofs is magnified during nighttime when the urban heat island reaches its maximum. Future simulations will explore the impact on the UM and energy load of mitigation strategies involving vegetation compared to high-albedo surfaces.

In some embodiments, the method includes improved surface temperature simulations through bias corrected assimilations of surface weather data from NYCMetNet stations. An improvement of the temperature simulation gives a better estimate of the energy consumption around the city. The method may also evaluate AC consumption simulations using energy data from the local energy company for specific locations in a city.

In view of the foregoing, embodiments of the disclosed method provide a more accurate estimation of predetermined energy consumption rates for urban environments. A technical effect is to permit utility companies to adjust energy production to satisfy a predetermined demand.

The disclosed method produces forecasts of optimal energy load balance for large buildings. It can be coupled to high resolution mesoscale weather and building energy model to forecast city-wide building energy demand, available on-site renewable energy (e.g., solar and wind), and deficits between renewable sources and the grid for energy storage optimization. The method provides forecasting of: a) renewable energy for each building within the domain (block, city, region), under any predicted weather event; past, present or future; and b) forecasting of the unbalance between total building energy demand and the renewable resource to meet total energy demand needs. The application of energy load balance for neighborhoods and cities has a wide range of potential applications for; utility companies to anticipate demands on their grid, for building managers to anticipate operation of energy production, for renewable energy companies to manage power production, delivery, and storage needs, for energy and carbon trading markets, and urban/building planners, among many other potential users. The proposed energy load balance forecasting application has global implications as it can be implemented to any city or neighborhood around the world. The method provides forecasting of renewable resource power generation, and consequently the deficit (or surplus) between the total load and the renewable power. The total energy need is lessened by the power generation from renewable resources and the energy storage need can be determined by examining the deficit or surplus.

Current building energy load forecasts are based on historical records for given locations, which may include electrical sub-stations, single buildings, or blocks of buildings, when correlated with demands and historical weather conditions. Current renewable energy forecasts are also based on correlations of the solar resource with long term environmental data. Short term forecasts (a few minutes) are based on cloud observations from satellite imagery. These approaches are used by utility companies and private renewable energy producers to prepare the grid and the corresponding energy production. These approaches do not distinguish between weather fluctuations from long-term norms, and/or spatial characteristics of the building, neighborhood or city. The disclosed method fills this technology gap by considering real time temporal fluctuations of local weather and specific characteristics of buildings, neighborhoods, and cities, including; building heights, materials, optical properties, HVAC and energy generation systems used, and usage by occupants.

The disclosed technology is based on significant modifications to existing numerical weather forecasting modeling systems to properly incorporate physical interactions between the atmospheric boundary layer and the built environment including energy exchanges between buildings and the environment. As a result, innovative processes have been conceived and developed that incorporate the modeling system with observations such that reliable future predictions of weather within the built environment can be made. Solar and wind energy resources and associated power productions and energy demands and usage at the building and city scales are inherent by-products of the forecasting process. Forecasting of weather, energy demands, and renewable energy production are possible at resolutions of 250 meters or less, for all buildings heights, hourly based, and several days ahead. These improvements in the modeling strategy for weather in cities, and its associated by-products on energy demands and renewable resource and generation have significant high commercial value.

The disclosed forecasting methodology incorporates both built environments and building dynamics resulting in an accurate, holistic approach for forecasting energy demands and renewable energy potential (and consequently deficit or surplus). This method provides the advantage over single building energy models of using the actual thermal relations to calculate loads, extending it to nearly any arbitrarily defined area. It also sidesteps the need of the artificial neural networks for historical training data, which may not be available for all buildings or for un-expected weather conditions.

In one embodiment, the disclosed forecasting product is based on well-known community mesoscale atmospheric models (e.g., WRF,) and their associated urban canopy models (UCMs) referred to elsewhere in this specification).

An example forecast for a single building energy loads is disclosed, where the daily 72-hour forecast for the whole city is used to deliver information for a single building specified by users. A graphics user interface (GUI) can be provided where the building is defined and a sample forecast for a selected small building. This information is delivered to the different users which could include facility managers and/or building owners. The commercial potential of this tool to provide forecast for all buildings within the city with a single city scale forecast is enormous. The value added to building operators is significant as they will have the necessary information to manage their peak loads days ahead avoiding excessive demand charges, which in many occasions may represent more than 30% of the total electrical bill of the facility.

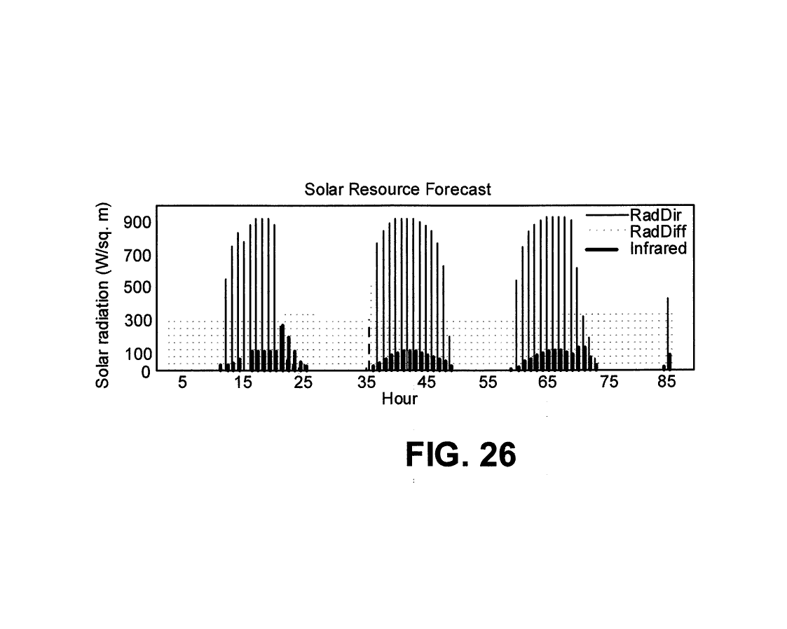

The model forecasts a current energy forecast for a specific day, the potential solar energy production for that current day, and the deficit between the demand and the solar capacity in the lower right panel. As expected, large and tall buildings will have the largest need for additional energy. The forecast of the solar resource is shown in FIG. 26, where all components of the incoming solar radiation are represented (total, direct normal, and diffuse) for a specific location in New York City. The total solar power is estimated by coupling the solar resource forecast to performance equations of solar photovoltaic panels. The forecast can also be extended to solar thermal systems and to urban wind generators.

This disclosure also provides a methodology for an energy forecast based on a coupled weather and building energy model producing energy demand data at a spatial resolution of 1 km×1 km for the entire city of New York. This method extends the functionality of single-building energy models by solving the energy balance equations over any arbitrarily defined area. It also sidesteps the need of the artificial neural networks for historical training data, which may not be available for all buildings. For cities to become sustainable throughout the 21st century under climate change and population increases, high-resolution monitoring and forecasting of building energy demand will play an important role. Although the model is able to model both heating and cooling loads, this work focuses on warm summer conditions as a driver of peak loads for the entire year. Anticipated knowledge of building loads can aid building owners and facilities engineers in the management of their resources to avoid upcoming peak demand events by preparing staff and equipment in advance. City-wide modeling can be used to evaluate the feasibility and economic impact of demand mitigation strategies at scales relevant to policy makers, such as cool roofs and increased heating, ventilation air conditioning (HVAC) efficiency. Within this context, the results of a coupled weather and building energy model are presented below for a test period in the summer of 2015.

The Urbanized Weather and Research Forecast Model. To quantify the building energy demand in New York City, this study employs an urbanized version of the Weather Research and Forecast (WRF) model, a state-of-the-art numerical weather prediction system developed and maintained by the National Center for Atmospheric Research. As a full-fledged numerical weather prediction system, WRF predicts the weather, including temperature, winds, incident radiation, and rainfall, among many other environmental variables. The weather variables can be used and modified by the physics modules activated in the model, which enables it to fully couple and solve the interactions between buildings and the atmosphere. In order to consider the contribution of the urban environment to the energy and momentum fluxes in the atmosphere, WRF has been configured to use the building environment parameterization (BEP), a multilayer urban parameterization that models the effects of radiation shadowing and trapping as well as modified versions of the turbulent length due the presence of buildings. Additionally, the building energy model (BEM), which quantifies the exchanges of heat between the interior of buildings and their environment such as through wall diffusion, air conditioning systems, and radiation exchanges through windows, is activated. BEM also uses bulk equipment and occupancy heat sources based on an hourly schedule to quantify the contributions of these components to the building energy budget. To make effective use of the BEP and BEM parameterizations, data corresponding to the urban morphology have been ingested into the model at a spatial resolution of 1 km×1 km corresponding to the high-resolution domain. This urban morphology has been adopted from the New York City Property Land Use Tax-Lot Output (PLUTO), which was released to the public as of 2013. Three parameters are derived from the PLUTO dataset: urban area fraction, building height, and land use. Urban building area fraction is derived from the PLUTO parameters as the ratio of building plan area to grid cell area:

$${λ}_{P} = \frac{{A}_{p}}{{A}_{T}}$$

The building plan area is calculated from the PLUTO total building floor area, garage area, and the number of floors:

$${A}_{p} = \frac{BldgArea - GarageArea}{Nunfloors}$$

To resolve the interactions between the land surface and the atmosphere, the NOAH land surface model (LSM), included in WRF, is used. The NOAH LSM makes use of land use classes to determine thermal, radiative, and hydrological properties of the land surface. With the PLUTO data, the Urban land use class (class 13) is disaggregated into three urban categories (low density residential, high density residential, commercial). The classifications used in the PLUTO dataset are translated to the same categories used in the National Land Cover Dataset (NLCD), as presented in Table 1, using the dominant class for each lot. This functions as a correction to the NLCD data set, which was found to overestimate the coverage of the Commercial urban classification over the city, especially in the boroughs of Queens and Brooklyn.

TABLE 1
Translation of PLUTO land use classification to WRF

| WRF urban categories | PLUTO land use classification |
|---|---|
| Low residential | One and two family buildings |
| | Parking facilities |
| High residential | Multifamily walk-up buildings |
| | Multifamily elevator buildings |
| | Industrial and manufacturing |
| Commercial | Mixed residential and commercial |
| | Commercial and office |
| | Transportation and utility |
| | Public facilities and institutions |

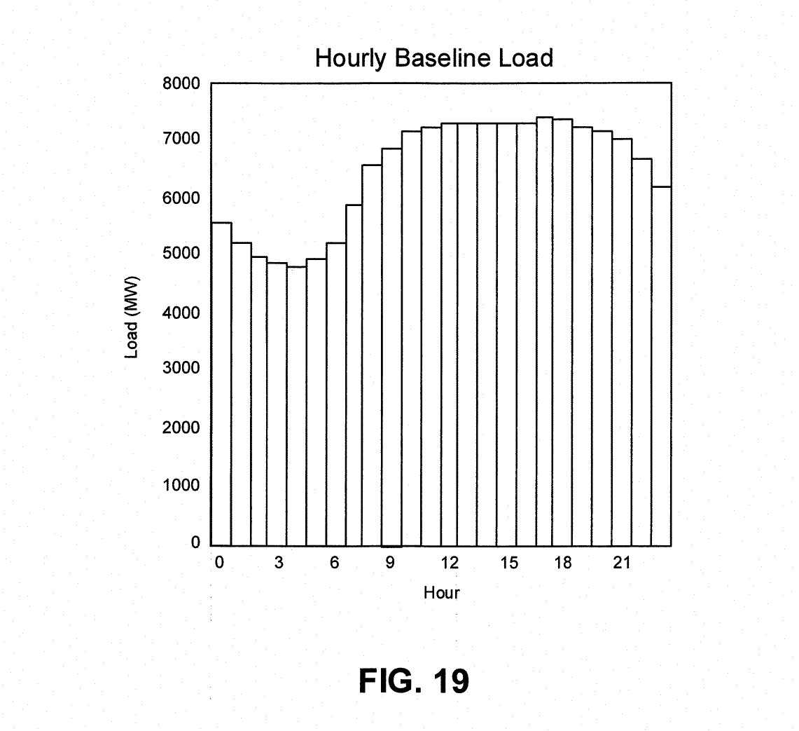

Since BEM only solves the building energy load due to space cooling and heating (i.e., HVAC loads), an additional baseline term to the city-wide energy demand must be added. This baseline load, assumed to be due to human behavior and nonbuilding associated loads, was calculated following the approach described by Salamanca et al. (Salamanca, F., Georgescu, M., Mahalov, A., Moustaoui, M., Wang, M., and Svoma, B. M., 2013, “Assessing Summertime Urban Air Conditioning consumption in a Semiarid Environment,” Environ. Res. Lett., 8(3), p. 034022.). The days where outdoor conditions corresponded to comfort levels, thus having the least demand for space cooling or heating, were determined to occur in early May (1-15), and late September (15-31) for the New York area. The human behavior component was then calculated as the average of the days where the minimum load, as well as the smallest diurnal variation, was found across these two time periods, resulting in the hourly baseline load shown in FIG. 19. Although profiles of nationwide energy use have been documented, like the Building America House Simulation Protocols, the authors found them to be inadequate for modeling of NYC energy consumption, given that the survey used is not representative of the city's urban canopy. For example, a multifamily unit is limited to three floors in the previously mentioned protocols, which would lead nearly all grid points within the city to be classified as commercial, similarly to the NLCD classification.

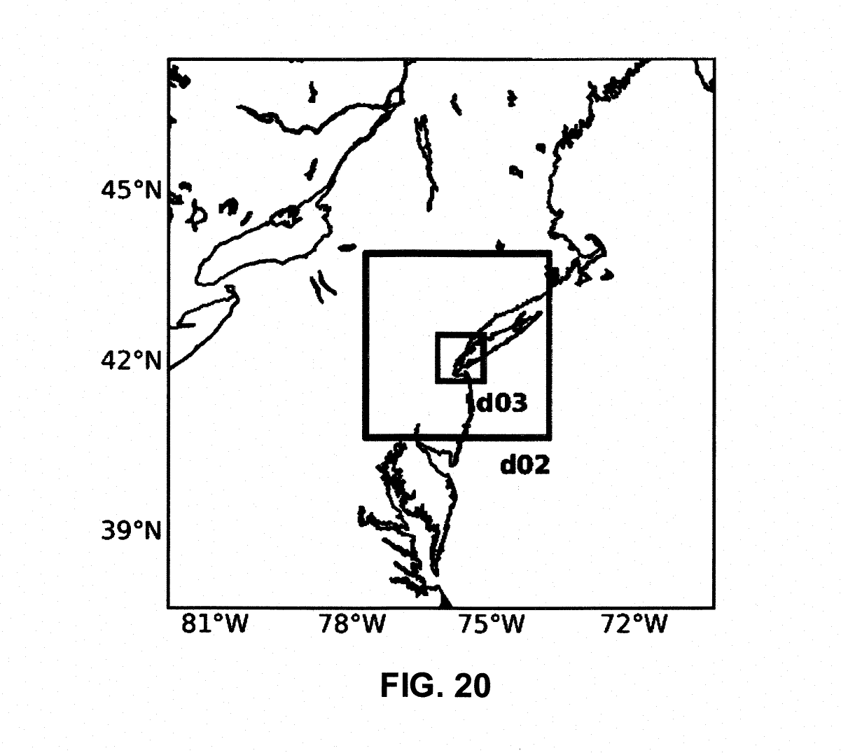

The urbanized WRF model has been set up to run at a spatial resolution of 1 km×1 km over the New York metropolitan area, where the highest urban density and variability in the region are found. Increased resolution is enabled by use of two-way nesting, where sub-domains with smaller grid spacing are embedded in areas of interest, using the parent domain's computed data as boundary conditions. The scheduling used for all buildings follows a similar profile for commercial buildings, varying only by the peak load as an initial attempt. Model domains are shown in FIG. 20, with the map extent delimiting the outer domain (d01) and the nested domains (d02 and d03) in squares. Due to the highly heterogeneous urban canopy in NYC, model detail is expected to increase with smaller grid spacing. However, for the city-wide bulk calculations studied here, this level of detail was deemed not necessary by the authors. Limitations are expected, especially due to the presence of Central Park, which have been addressed through the weather station comparison presented in the following section, Model Validation. Biases introduced by the presence of the park could also be decreased by use of adaptive grid spacing. However, this capability is not available in WRF for the horizontal grid. A coarser grid spacing (such as a 2 or 3 km grid) would reduce the level of urban canopy detail ingested, limiting the number of grid points within Manhattan (where the highest consumption density lies) to one or two at most. Fifty one vertical levels are used in the atmospheric component with a time step of 45 s for the coarsest domain, with each nested domain having three time steps per parent domain calculation. The model was configured to use the rapid radiative transfer model (RRTM) for longwave radiation, the Dudhia scheme for shortwave radiation, the Mellor-Yamada-Janjic planetary boundary layer scheme, the Kain-Fritsch cumulus parameterization, and the WSM6 microphysics. Additionally, the cumulus parameterization is turned off in the 1 km resolution domain (d03), to allow the model to resolve these processes explicitly. A summary of the model parameterizations used is given in Table 2.

TABLE 2
Summary of physics parameterization used in the
urbanized WRF model as configured for this study

| Model physics | Scheme |
|---|---|
| Land surface model | NOAH LSM |
| Longwave radiation | RRTM |
| Shortwave radiation | Dudhia scheme |
| Planetary boundary layer | Mellor-Yamada-Janjic |
| Cumulus | Kain-Fritsch |
| Microphysics | WSM6 |

The model data used in this study consist of 0-24 h forecasts initialized with the three-hourly 12 km horizontal resolution North American Mesoscale (NAM) model once a day ranging from Jun. 15, 2015 to Jul. 6, 2015, a period of 22 days including a heat wave starting on June 23 with a 12 h spin-up period and saved hourly.

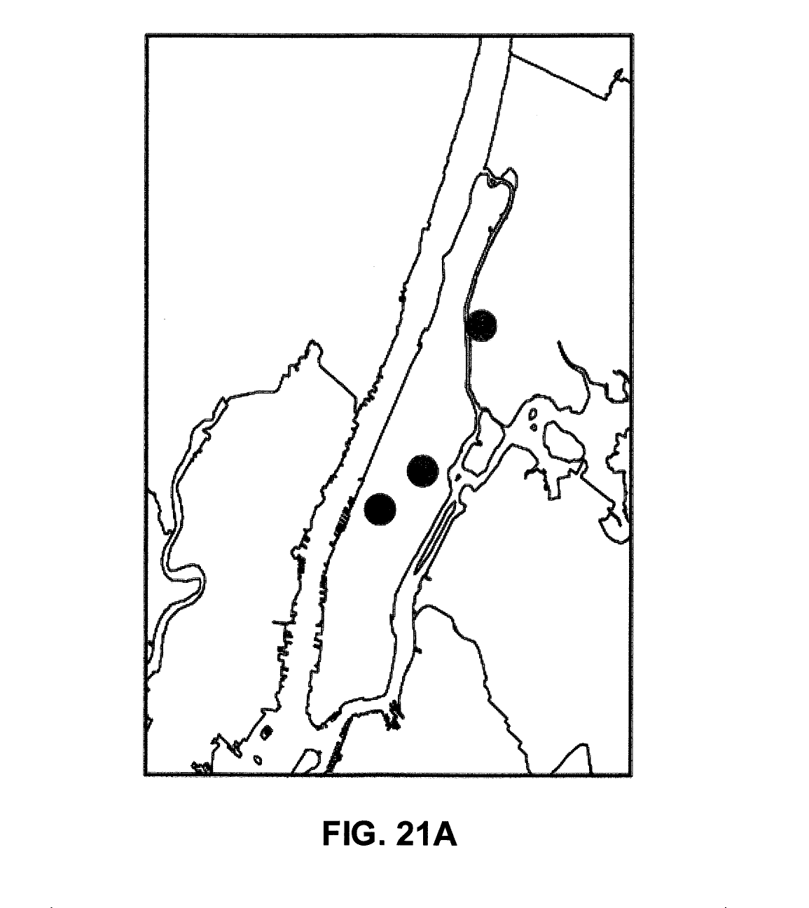

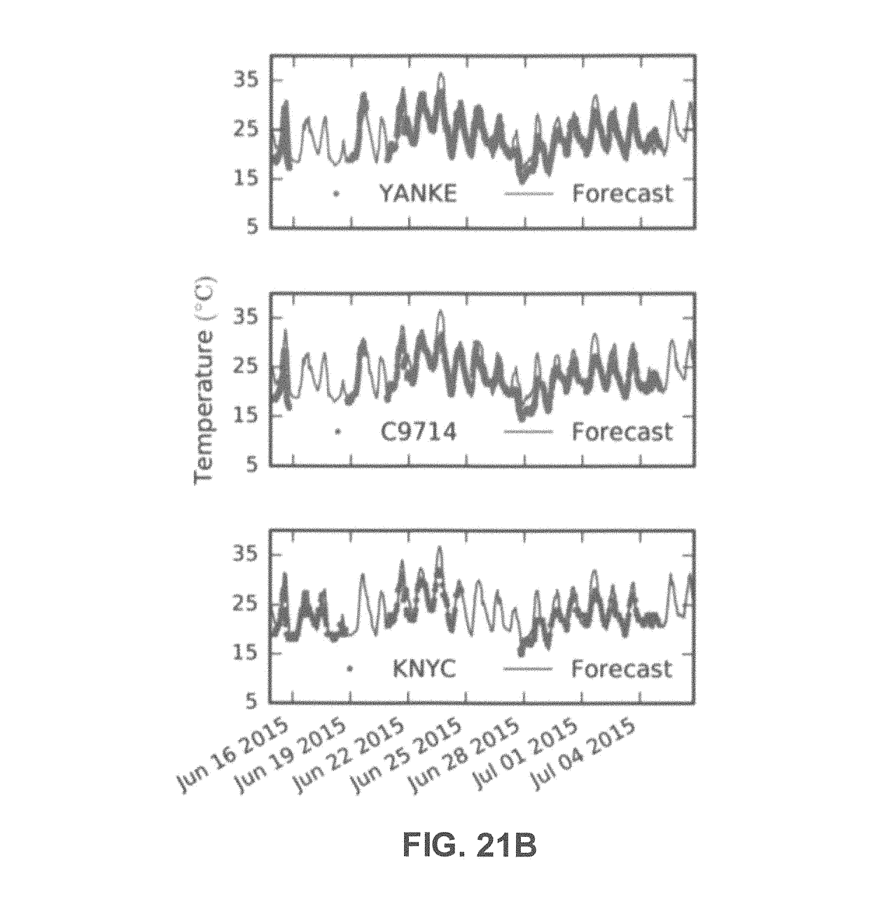

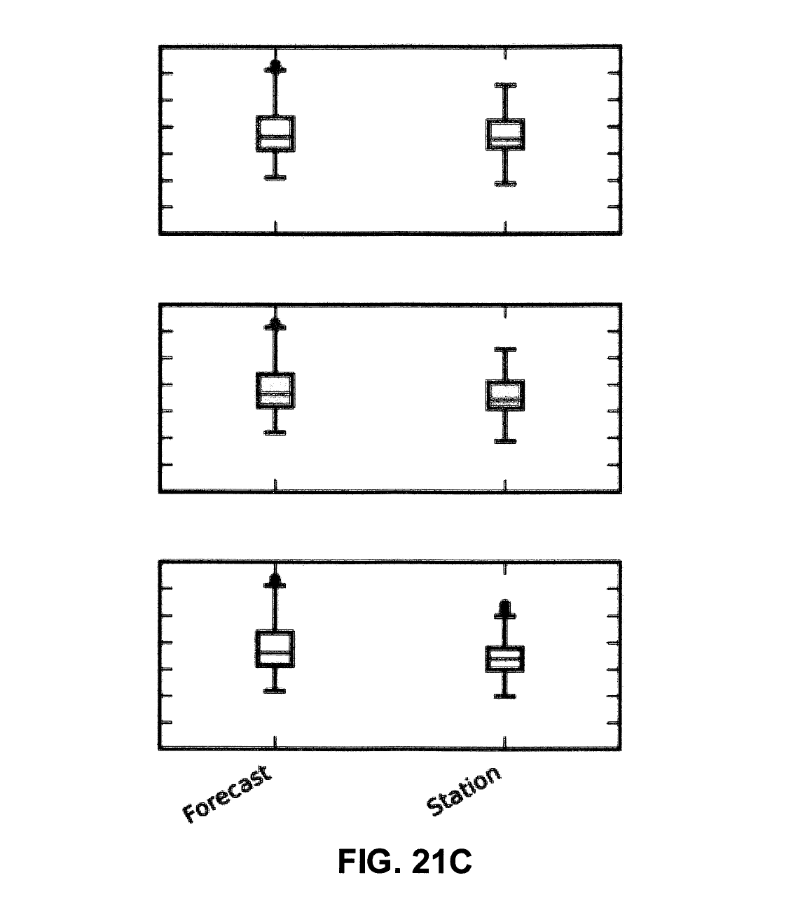

Model Validation. The results of the weather component of the model were compared to stations located in New York City (FIG. 21A) from the NYC-MetNet network. NYC-MetNet compiles and archives data from over a hundred weather stations with a wide array of instruments measuring surface temperatures, winds, and rainfall, among others. Performance statistics for the weather such as the root mean square error (RMSE) and mean absolute error (MAE) were calculated. The energy demand was aggregated for the entire city by adding all the grid points and then compared to data archived by the New York Independent System Operator (NYISO) for the NYC load zone (J). The NYISO is a nonprofit entity that manages the electric grid and the wholesale electricity markets, and as such keeps an archive of the total load requested by the state, divided into load zones. The load data provided represent the total electric load for NYC, including buildings, street lighting, and public infrastructure such as the subway system. For the analysis period, weekends have been excluded, as the model considers only weekend schedules.

All simulations were carried out using the College of Staten Island High Performance Computing Center (CSI-HPCC) resources. Each simulation used 128 compute cores (at 16 cores/node) and lasted 4.5 h per 72 h of model time.

Case Study Configuration: An assessment of the use of white roofs is presented as a case study of the city-scale building energy model potential use. A white roof is a mitigation solution that aims to reduce building cooling loads by changing the reflective properties of roofs. By increasing the reflectivity of roofs, the surface energy balance is modified, reducing the absorbed portion of the incoming solar radiation. The performance of white roofs has been widely studied, as is evident by the wealth of literature available. To obtain the potential energy savings of a city-wide white roof installation during a high-temperature event, the roof reflectivity of the three urban land use classes was changed from the default of 0.20 to 0.80. All other roof and building properties were kept the same as the validation period's values. The case study uses the warmest three days of the validation period, from Jun. 21, 2015 to Jun. 24, 2015. An assessment of the spatial potential energy savings was carried out, including percent savings in air conditioning demand.

Results

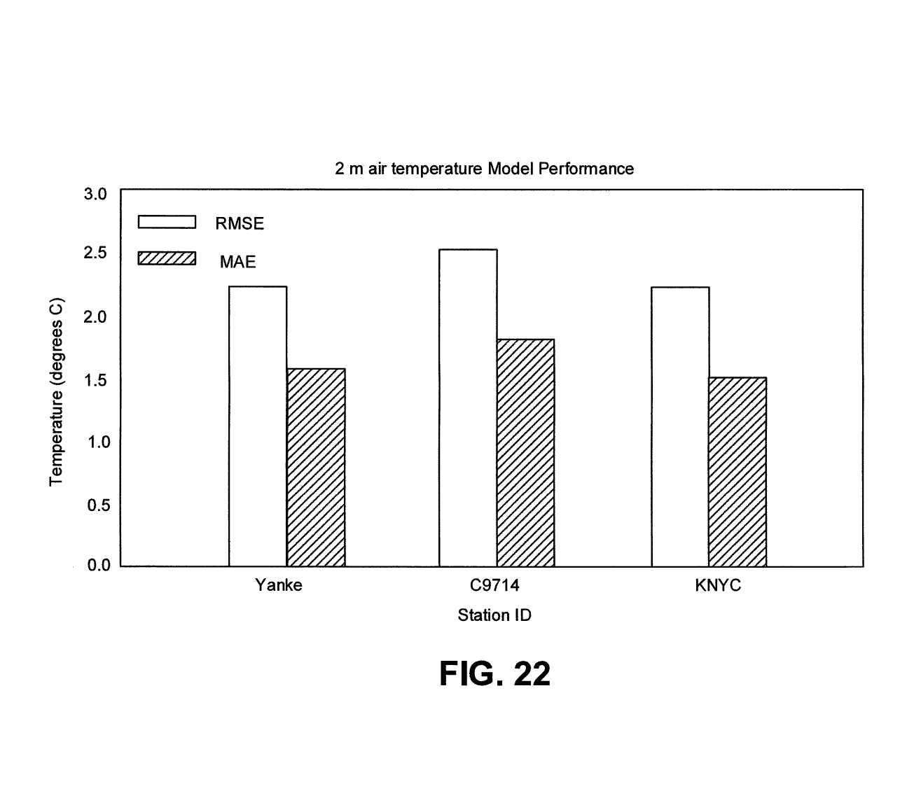

Station Surface Temperature: Temperature is one of the main drivers of energy consumption for air conditioning, along with air moisture content and incoming solar radiation. FIG. 21B shows a time series of the study period for all three stations. The timing of the peak temperature is well represented in all three stations, with the diurnal temperature cycle being well represented by the model forecast. The model overestimates the peak temperatures, most notably on some of the wanner days (e.g., July 23). The minimum temperatures, however, are very well represented. This overestimation of the peak temperature over the city is due in part to an overestimation of the sensible heating in the BEP and BEM schemes. However, as can be seen in FIG. 21C, the temperature distributions between the forecast and the stations do not show a large spread when compared to each other, except in the KNYC station at Central Park. This may be in part due to the station's location in a vegetated area, which is not fully resolved in the land use at a spatial resolution of 1 km. Overall, however, the error distribution is similar between all three stations, as can be seen in FIG. 22.

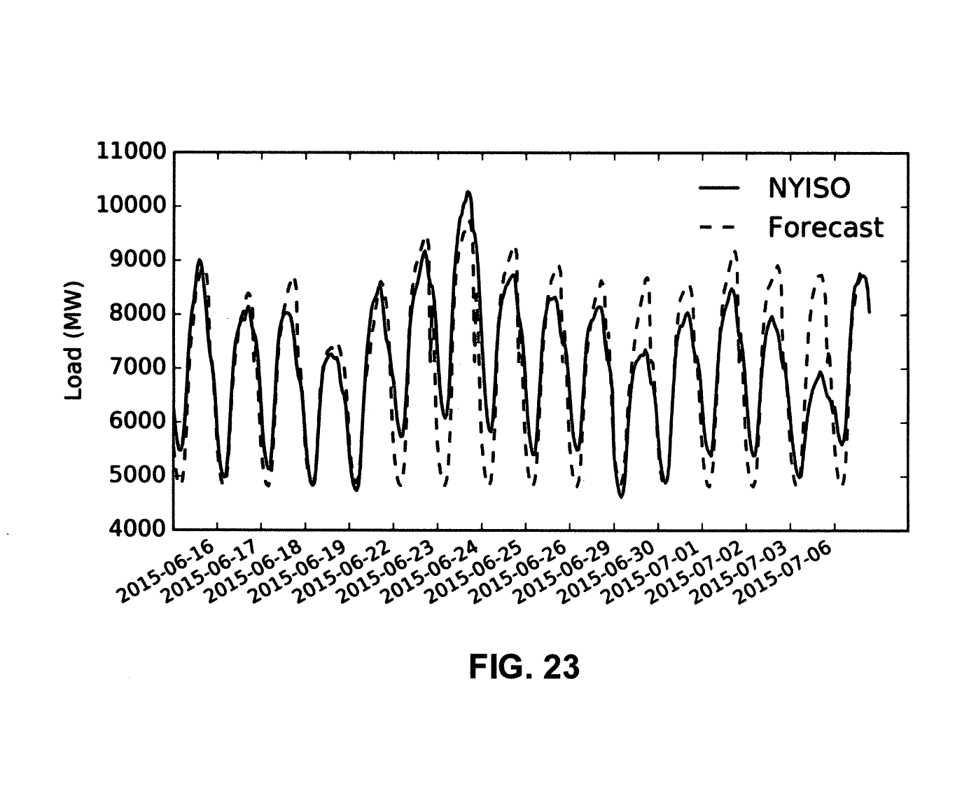

City-Scale Load. The coupled weather-building energy model is used to produce a gridded, hourly building energy demand. FIG. 23 shows the average peak distribution of air conditioning load by taking into account both the weather effects and the parameterized urban morphology. To obtain the city-scale load from the forecast, the gridded 1 km resolution model air conditioning consumption (W/m²) was multiplied by the building area fraction and the actual grid spacing area (1 km²), yielding the total building energy demand per grid point. The equipment load is then added to the air conditioning load, as well as a baseline constant value corresponding to city-scale nonbuilding energy use that is not accounted for in BEM such as the subway system and street lighting. A constant value of 0.5W/m² based on data from the New York City Department of Transportation lighting design document, the Metropolitan Transportation Authority, and the New York State Energy Research and Development Authority (NYSERDA) report on street lighting and aggregated as follows:

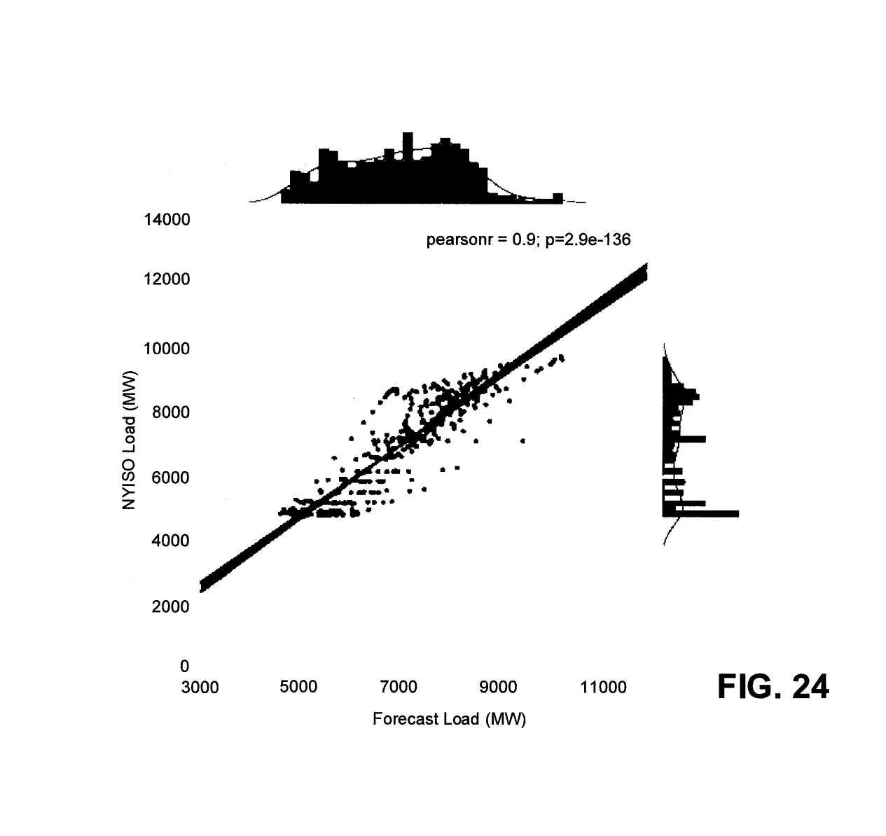

TE=E_{AC}+E_{baseline}

where TE is the total energy demand, EAC is the air conditioning energy demand, and E_{baseline} is the hourly varying baseline energy demand. As can be appreciated from the time series (FIG. 23), the forecast is able to capture the diurnal cycle of the energy demand. Two days stand out from the time series, June 23 and July 3. The former day had the highest peak temperatures of the period of study, leading to increased demand for space cooling. While the model captures the diurnal variability of this event in terms of electric load, it misses the actual peak value by close to 400 MW. Meanwhile, July 3 may have been a work holiday for many institutions, leading to decreased demand across the city. As observed in FIG. 24, the model shows good agreement with the observations. The predicted values perform better in the afternoon, when high-summer temperatures dominate the cooling demand variability. However, at night, when temperatures are close to the model set point of 298 K, the cooling demand drops to close to 0 W/m², yielding a nearly constant daily minimum load. The root mean square error for the predicted values over the study period was 669.54 MW, with an R² of 0.805 and p-value of 2.9×10⁻¹³⁶, indicating a good fit.

White Roof Case Study. In addition to model validation, a case study was performed to assess the value of the model as an evaluation tool of peak demand mitigation. Due to the heterogeneity of the weather and urban morphology across the city, including the density of large volume buildings, savings are not spatially uniform. Although the distribution of building energy demand per square meter followed a similar pattern across the city, the magnitudes were reduced slightly across the board. The percent savings in HVAC energy demand ranges from a minimum of close to 0% in nonurban areas and close to the Central Park area of Manhattan, to 8-16% in the Bronx, Brooklyn, and Queens boroughs. These results are certainly within the range of expected values. This seems to indicate a larger potential benefit of white roof installations in the less highly dense urban areas in the city, although a longer term modeling study could shed more information on this.

In the context of future buildings and cities, this work presents an energy forecasting for dense cities and neighborhoods using a unified, holistic built natural environment system. This approach opens opportunities for exploration of energy demands of future cities in the context of future climates, future building technologies, and human behavior.

Solar Applications

Recent developments in the Weather Research and Forecasting (WRF) Model have made it possible to accurately estimate incident solar radiation. This study couples the WRF□Solar module with a multi□layer urban canopy and building energy model to create a unified WRF forecasting model. This article tests this integrated approach for the case of New York City (NYC) metro region as sample case. Hourly forecasts are validated against ground station data collected at eight different sits in and around the city. Validation is carried out independently for clear and cloudy sky conditions. Results indicate that the uWRF□Solar model can forecast solar irradiance considerably well for the global horizontal irradiance (GHI) with an R squared value of 0.93 for clear sky conditions and 0.76 for cloudy sky conditions. Results are further used to directly forecast solar power production in the region of interest, where evaluations of generation potential are done at the city scale. Outputs show a gradient of power generation produced by the potential available solar energy on the entire uWRF□Solar grid. In total, for the month of July 2016, the city had a city PV potential of 233 kW/day/m² and 7.25 MWh/month/m².

Solar photovoltaic (PV) systems in dense cities have become very important over the last few years. With this increase of solar PV power, many utility and power operators are facing the challenge of PV power integration due to the uncertain nature of the solar energy resource. PV power depends on the solar irradiance incident to the solar panel array, but this resource has a high variability making it necessary to find ways to predict its behavior. This is truer in complex environments such as large cities where there is large potential for increased number of PV roof top installations. By doing so, the utility and power operators may have the ability to properly manage the input/output balance of their system to correctly integrate various energy sources with maximum efficiency.

The WRF model, developed by the National Center for Atmospheric Research (NCAR), is a unique NWP model used for weather related research and forecasting. The WRF model can be customized to meet a wide spectrum of applications, achieving this with options for several physical processes and parameterizations. Some of these options include the ability to define a specific shortwave parameterization scheme.

One specific augmentation of the WRF model includes WRF□Solar, a set of parameterizations created to improve solar irradiance forecasting for the use in solar energy applications. This includes an aerosol optical property parameterization added to capture the effects of radiation scattering and absorption by aerosols and a shallow cumulus parameterization scheme.

A second capability includes an integrated urban modeling system within the WRF model through a series of parameterizations. This allows the NWP model to address urban environmental effects in large urban centers. These urban Building Effects Parameterization coupled to a Building Energy Model allow the WRF model to take into account the radiation shadowing, reflection and entrapment within the street canyons caused by urban buildings, and to account for the urban heat fluxes caused by heat exchanges within an urban building.

In this investigation the WRF□Solar parameterization is coupled with a multi□layer urban canopy and building energy model to create a unified WRF forecasting model called uWRF□Solar. The new unified forecasting tool is tested here for the case of NYC representing a first time evaluation of this unified approach. A validation is carried out between the forecasted data and ground station observations to analyze how well the urban parameterization and the WRF□Solar model interacts. Once these forecasts are validated, accurate PV power forecasting can be achieved using a two□step approach. The first step involves forecasting relevant weather□related variables that are necessary in PV power production. The second step converts these uWRF□Solar forecasts into PV power by using a PV physical model that solves for the electrical performance of a PV array. The overall objective of this study is to validate the uWRF□Solar outputs and create a framework that offers a novel approach in forecasting PV power to any urban region that runs WRF with the urban parameterizations on.

Methods

WRF□Solar Description: WRF□Solar, built on WRF version 3.6.1 provides the added capability of improved solar forecasting through developments in the cloud□aerosol□radiation feedback system. WRF□Solar adds both the DNI and DIF component of solar irradiance as a direct output of the WRF model. An aerosol optical property parameterization is also added to capture the effects of radiation scattering and absorption by aerosols, known as the aerosol direct effect. Finally, small cloud interactions with irradiance are considered in the WRF model using a new shallow cumulus parameterization scheme.

Urbanized WRF Description: The urbanized WRF model (uWRF) includes two specific parameterizations that allow to consider the influence of large urban centers in the energy and momentum fluxes of the atmosphere. The building environment parameterization (BEP) is a multilayer urban parameterization that models the atmospheric effects caused by urban buildings and includes heat flux adjustments to account for radiation shadowing, reflection and entrapment within the street canyons. The building energy model (BEM) is then coupled with the BEP to account for urban heat fluxes caused by heat exchanges between the buildings and the environment. This includes the heat transfer between the walls, floors, and roofs of a building, the solar radiation heat exchange through windows and the effects of air conditioning, heating, and ventilation. To run these parameterizations, sub□grid building fractional area data set is required to represent the urban landscape and drive the uWRF model. Most of previous uWRF applications have explored extreme heat events in cities which are considered to represent high health risks for the population. In this work, the urban building fractional area data set requirements are obtained from the Property Land Use Tax□Lot Output (PLUTO) dataset at a spatial resolution of 100 m. This in turn gets upscaled to a 1 km×1 km domain to match the high□resolution WRF domain.

uWRF□Solar Description: In this investigation, the WRF□Solar shallow cumulus parameterization scheme is activated and coupled with the BEP+BEM urban model to create a unified WRF model, referred on forwards as uWRF□Solar. This model was set up using WRF v 3.6.1 and configured with three two□way nested domains at horizontal resolutions of 9, 3, and 1 km as shown in FIG. 20. The 1 km×1 km domain was the primary focus of this investigation, as it is the domain primarily encompassing the NYC region with the highest urban density. The uWRF□Solar model was configured to use the rapid radiative transfer model (RRTM) scheme for longwave radiation, the Rapid Radiative Transfer Model for Global Circulation Models (RRTMG) scheme for shortwave radiation, the Mellor-Yamada-Janjic planetary boundary layer scheme, and the WSM6 microphysics. A summary of the model's physics parameterizations used in this investigation is given in Table 3. The model outputs consist of 0□24□hour forecasts simulated with a time period ranging from Jul. 1, 2016 to Aug. 31, 2016.

TABLE 3

| | |
|---|---|
| Land surface model | NOAH LSM |
| Longwave radiation | RRTM |
| Shortwave radiation | RRTMG |
| Planetary boundary layer | Mellor-Yamada-Janic |
| Microphysics | WSM6 |

uWRF-Solar Additions

| | |
|---|---|
| Shallow cumulus | PSU-Deng |
| Urban surface | BEP + BEM |

Station Data Description: Model results were validated against ground station data collected at eight meteorological stations within the uWRF□Solar model domain. T he data was collected to match the time□period of the forecasts, from Jul. 1, 2016 to Aug. 31, 2016. The first two sites are located inside the 3 km×3 km uWRF□Solar domain. This includes the first site managed by the meteorological services at Brookhaven National Laboratory (Upton, N.Y.) and measures GHI data using a Kipp and Zonen CMP□22 pyranometer at a time interval of one□minute. The U.S Climate Reference Network (USCRN) manages the second site located in Millbrook, N.Y. This site provides GHI data measured from a Kipp and Zonen SP Lite2 pyranometer already reprocessed in hourly intervals. The last six stations are managed by the New Jersey Weather and Climate Network and are located inside the 1 km×1 km model domain surrounding the NYC region. Each of these sites provide GHI data using an Apogee SP□110 pyranometer containing irradiance data at a time interval of five□minutes.

Evaluation Method: To validate the uWRF□Solar model, hourly GHI outputs with a 24□hour forecast horizon were evaluated against ground station data. Different suitable performance statistics and measures of error were used, such as the root mean square error (RMSE), mean absolute error (MAE), and the correlation coefficient (R²) using data separated into two different groups: clear sky and cloudy sky conditions.

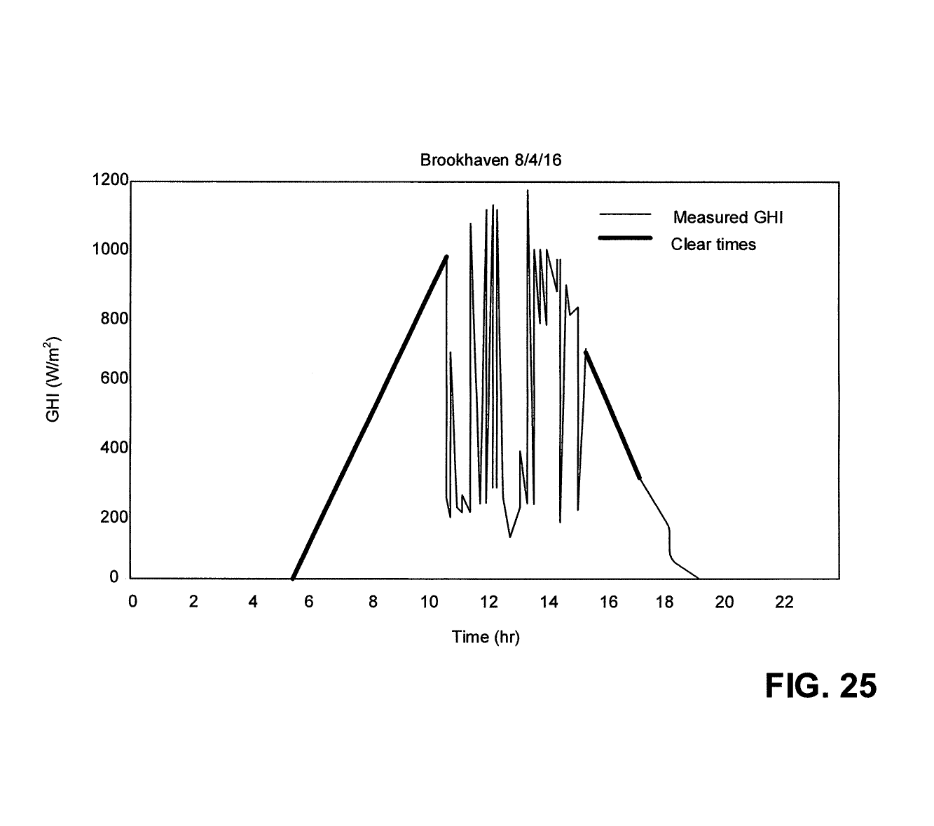

Cloud conditions were determined based on a clear sky detection algorithm driven by observed GHI measurements as implemented in the PVLib Toolbox. The algorithm works by comparing the measured GHI data to a theoretical clear sky GHI model using five different test conditions as outlined by Reno et al. (see priority application 62/584,294). If the GHI measurement satisfies the five test conditions, then the time□period will be flagged as a clear sky. The results of this algorithm can be seen in FIG. 25 where the clear times are flagged with a thick marker.

Generating PV Forecasts: To generate the PV power forecast for NYC, a PV simulation model was used to output power for the entire domain grid of 1 km×1 km. Hourly irradiance forecast data from the uWRF□Solar model was used to drive the model. Temperature and wind forecasts from uWRF□Solar were also used to estimate PV module temperatures, since the operating temperature of a PV module has a distinct effect on its electrical efficiency. Once this power forecast was generated for the entire NYC region, the building area fractional dataset was used to calculate the fluxes per building unit area and a total power estimate was derived. The PV power model used in this investigation follows a three□step approach including:

(1) Estimating the total irradiance on an angled surface using the Liu□Jordan transposition model, a simple model that assumes an isotropic diffuse sky and is defined as follows:

$${I}_{T} = {I}_{DNI} {R}_{b} + {I}_{DIF} ( \frac{1 + cos ( β )}{2} ) + {I}_{GHI {ρ}_{g}} ( \frac{1 + cos ( β )}{2} )$$

wherein I_{T} is the total irradiance on an angled surface I_{DNI}, is the DNI on a horizontal surface, R_{b} is the ratio of beam irradiance on a tilted surface to that on a horizontal surface, I_{DNI} is the DIF component of irradiance, β is the tilt angle, I_{GHI} is the GHI component of irradiance, and ρ_{g} is the surface albedo.

(2) Finding the PV module efficiency as a function of temperature and wind forecasts. The PV cell temperature and efficiency are defined as follows:

$${T}_{c} = \frac{{U}_{pv} ( υ ) \cdot {T}_{a} + I [ τ \cdot α - {η}_{STC} ( 1 - {β}_{STC} \cdot {T}_{STC} ] )}{{U}_{pv} ( υ ) + {β}_{STC} \cdot {η}_{STC} \cdot I}$$

where T_{c} is the PV cell temperature, I is the in□plane irradiance, T_{α} is the ambient temperature, υ is the wind speed, τ is the transmittance of the cover system, α is the absorption coefficient of the cell, the value τ·α=0.81, T_{STC} has been estimated to be the temperature at standard test conditions and both η_{STC} and β_{STC} are the efficiency and temperature coefficient of maximum power under standard test conditions. A heat exchange coefficient Uₚᵥ(υ) for the total surface was calculated as follows:

Uₚᵥ(υ)=26.6+2.3υ

The formulation for efficiency can then be found:

η_{cell}=η_{τ}[1−β(T_{c}−T_{τ})+γlogϕ]

where η_{τ} is the reference efficiency taken at a cell temperature T_{τ} of 25° C. and at a solar irradiance ϕ of 1000 W/m², γ is the solar irradiance coefficient and is usually taken to be γ=0.12 for a silicon module and β is the temperature coefficient that is usually taken to be β=0.0048 ° C.⁻¹ for a silicon module as well.

(3) Finding the PV power output with respect to the total irradiance on an angled surface and the PV module efficiency as a function of temperature and wind forecasts. where:

P_{PV}=A_{c}·Iₜ·ηₑ·η_{cell}

where A_{c} is the area and ηₑ is the DC to AC derate factor.

Validation: Error values for GHI forecasts are presented as a function of sky conditions in Table 4 and Table 5. The tables summarize the performance of the uWRF□Solar model for the eight chosen locations under clear sky conditions and cloudy sky conditions normalized with the averaged measured GHI. The averaged error metrics of all location were then taken and analyzed. According to the data collected, statistical results indicate that the uWRF□Solar model can forecast solar irradiance considerably well for the GHI with an averaged R² value of 0.93 for clear sky conditions and 0.76 for cloudy sky conditions. By looking at these results it is evident that the forecast has a high dependency on sky conditions. On average, the MAE for GHI during clear sky conditions was 11.08%. This value increased to 20.31% when cloudy sky conditions occurred. The same can be said with the averaged RMSE, for clear sky conditions the value was 18.71% whereas for cloudy conditions this number jumps to 41.55%.

TABLE 4
Clear Sky condition: Statistical metrics
for uWRF-Solar model validation

| Station | R² | RMSE (%) | MAE (%) |
|---|---|---|---|
| Brookhaven | 0.99 | 9.1 | 6.1 |
| Carry | 0.88 | 22.5 | 9.7 |
| Jersey City | 0.89 | 25.3 | 15.1 |
| Charlotteburg | 0.95 | 17.9 | 10.3 |
| Haworth | 0.97 | 15.2 | 10.8 |
| Basking Ridge | 0.98 | 12.4 | 9.2 |
| Holmdel | 0.93 | 20.7 | 12.3 |
| New Brunswick | 0.86 | 26.6 | 15.0 |

TABLE 5
Cloudy sky condition statistical metrics
for uWRF-Solar model validation

| Station | R² | RMSE (%) | MAE (%) |
|---|---|---|---|
| Brookhaven | 0.76 | 40.5 | 18.5 |
| Carry | 0.76 | 41.2 | 19.5 |
| Jersey City | 0.76 | 41.2 | 20.7 |
| Charlotteburg | 0.78 | 40.8 | 19.9 |
| Haworth | 0.77 | 40.1 | 19.6 |
| Basking Ridge | 0.78 | 40.0 | 19.4 |
| Holmdel | 0.72 | 44.0 | 22.1 |
| New Brunswick | 0.74 | 44.6 | 22.9 |

The error metrics between an urban site and a rural site will now be considered, specifically between the Jersey City (Urban) site and the Brookhaven (Rural) site, respectively. Table 4 shows that the GHI has different R² values for clear sky conditions. The Brookhaven site has a R² value of 0.99, a RMSE of 9.1% and a MAE of 6.1%, indicating high accuracy in GHI forecasting. In contrast, these validation metrics fall short to an R² value of 0.88, a RMSE of 22.5% and a MAE of 9.7% for the Jersey City site. Under cloudy sky conditions, as shown in Table 5, the Brookhaven site and Jersey City site have very similar error metrics. The R² value for both these sites are the same, the RMSE is slightly lower in the Brookhaven site with a value of 40.5% versus Jersey City of 41.2%. Finally, the MEA follows a similar pattern with Brookhaven slightly lower with a value of 18.5% verses Jersey City of 20.7%.

PV Forecast Case Study: In addition to the uWRF□Solar model's validation, a case study was performed for the month of July 2016 to assess the value of the model as an evaluation tool for potential solar power forecast in the NYC region. In this disclosure, the following assumptions were made: (1) All roof area per grid is available depending on the building area fractional Dataset (2) All buildings have flat roofs with PV panels at an optimal tilt angle equal to that of the latitude (3) PV module has a reference efficiency ηₑ=15.3%, temperature coefficient of maximum power under standard test conditions β_{STC}=−0.28%/° C. (4) DC to AC derate factor of 93%.

Potential maximum PV power was first obtained using the uWRF□Solar models solar output for the entire month of July. The hourly power output at 3 pm for each day was taken and averaged across the entire domain. The average PV power peak at each grid point was about 22.1 W/m². A similar analysis was then performed to find the average daily total power for the entire region of interest. By averaging every grid point, it is shown that the average daily total is 203.6 Wh/day/m². From this information, it was found that the entire city PV potential was 233 kW/day/m² and 7.25 MW/month/m². It can be noted the gradient of solar power across the city with maximum power generation in areas with most building density. This is expected from the assumption that available urban fraction is also available for power generation.

In this disclosure, a NWP model was used to obtain forecasts corresponding to solar irradiance for an urban region. The model was set up to include a new parameterization of WRF referred to as WRF□Solar, where the new modifications focused on improving numerical outputs for use in solar energy applications. The model also considered the effects of large buildings in the city with the use of a building environment parameterization and a building energy model to analyze how urban morphology affects available solar resource. The unified urbanized NWP model coupled to a solar forecasting parameterization was tested for the case of NYC, albeit it can be applied in any major urban center.

The solar irradiance component of the forecast system was compared to ground station data measured at eight separate meteorological stations across the uWRF□Solar domain in NYC and surrounding areas. It was shown that uWRF□Solar model could forecast solar irradiance considerably well for GHI with an averaged R² value of 0.93 for clear sky conditions and 0.76 for cloudy sky conditions. It was also shown that the averaged MAE for GHI during clear sky conditions was 11.08% and 20.31% during cloudy sky conditions. When compared to previous studies, the uWRF□Solar model had lower values of both MAE and RMSE under clear skies. These discrepancies were attributed to the lack of urban aerosols representation in the uWRF-Solar model. When comparing the uWRF□Solar model to similar forecasts for Andalusia, Spain under cloudy sky conditions, the uWRF□Solar model performed well, illustrating the benefit of combining WRF□Solar with the urban surface parameterization.

A case study was performed to assess the value of the model as a forecast tool of the potential of solar for a major urban center. This case study used forecasted solar irradiation data for the month of July 2016 and ingested it into a PV power model for NYC. The model showed that the average total solar resource at each grid point was around 22.1 W/m². It was also found that the entire city PV potential in NYC was 233 kW/day/m² and 7.25 MW/month/m².

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a non-transient computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for forecasting energy demand for a building in an urban environment, the method comprising steps of:
determining a predicted weather condition of an urban environment at a predetermined time using a weather forecasting model;
finding, using a building energy model, an impact of the predicted weather condition on an urban heat island (UHI) of the urban environment, the step of finding producing a weather-adjusted UHI condition;
quantifying a predicted energy consumption rate for a building in the urban environment at the predetermined time based on the weather-adjusted UHI condition that incorporates the impact of the predicted weather condition on the urban heat island (UHI), wherein the building energy model segments the urban environment into uniform grids with a grid size, the grid size selected to group buildings with a uniform horizontal distribution together;
forecasting renewable energy power production for the building in the urban environment, wherein the renewable energy power production is produced by a renewable energy source;
estimating an energy deficit from the renewable energy source by finding a difference between the predicted energy consumption rate and the renewable energy power production;
balancing energy production between (1) the renewable energy source and (2) energy from an energy grid source, the balancing being based on the energy deficit.

2. The method as recited in claim 1, wherein the renewable energy source is a solar power source and the energy grid source is a non-solar power source.

3. The method as recited in claim 1, wherein the grid size is selected to group buildings with dark roofs together.

4. The method as recited in claim 3, wherein the grid size is selected to group buildings with white roofs together.

5. The method as recited in claim 1, further comprising presenting results of the step of quantifying in units of energy consumption per unit time.

6. The method as recited in claim 1, wherein the building energy model comprises a Building Energy Parameterization (BEP) that accounts for thermal impacts from horizontal and vertical building surfaces of the building.

7. The method as recited in claim 1, wherein the building energy model comprises a Building Energy Model (BEM) that accounts for consumption of energy due to air conditioning (AC) systems.

8. The method as recited in claim 7, wherein the Building Energy Model (BEM) accounts for generation of heat due to the air conditioning (AC) systems.

9. The method as recited in claim 7, wherein the Building Energy Model (BEM) accounts for diffusion of heat through walls, roofs and floors.

10. The method as recited in claim 1, wherein at least 40% of buildings within the uniform grid have a height greater than ten meters.

11. The method as recited in claim 1, wherein the method forecasts the energy consumption rate over a time frame, wherein the predetermined time is within the time frame.

12. A method for forecasting energy demand for a building in an urban environment, the method comprising steps of:
determining a predicted weather condition of an urban environment at a predetermined time using a weather forecasting model;
finding, using a building energy model, an impact of the predicted weather condition on an urban heat island (UHI) of the urban environment, the step of finding producing a weather-adjusted UHI condition;
quantifying a predicted energy consumption rate for a building in the urban environment at the predetermined time based on the weather-adjusted UHI condition that incorporates the impact of the predicted weather condition on the urban heat island (UHI), wherein the building energy model segments the urban environment into uniform grids with a grid size, the grid size selected to group buildings with a uniform mean building height together;
forecasting renewable energy power production for the building in the urban environment, wherein the renewable energy power production is produced by a renewable energy source;
estimating an energy deficit from the renewable energy source by finding a difference between the predicted energy consumption rate and the renewable energy power production;
balancing energy production between (1) the renewable energy source and (2) energy from an energy grid source, the balancing being based on the energy deficit.

13. The method as recited in claim 12, wherein the renewable energy source is a solar power source and the energy grid source is a non-solar power source.

14. The method as recited in claim 12, wherein the grid size is selected to group buildings with dark roofs together.

15. The method as recited in claim 14, wherein the grid size is selected to group buildings with white roofs together.

16. The method as recited in claim 12, wherein the building energy model comprises a Building Energy Model (BEM) that accounts for consumption of energy due to air conditioning (AC) systems.

17. The method as recited in claim 16, wherein the Building Energy Model (BEM) accounts for generation of heat due to the air conditioning (AC) systems.

18. The method as recited in claim 16, wherein the Building Energy Model (BEM) accounts for diffusion of heat through walls, roofs and floors.

19. The method as recited in claim 12, wherein at least 40% of buildings within the uniform grid have a height greater than ten meters.

20. The method as recited in claim 12, wherein the method forecasts the energy consumption rate over a time frame, wherein the predetermined time is within the time frame.
